(19) United States
(12) Patent Application Publication
(10) Pub. No.: US 2024/0276981 A1
(43) Pub. Date: Aug. 22, 2024

(54) NOVALURON SOLID COMPOSITION

(71) Applicant: Adama Makhteshim Ltd., Beer Sheva (IL)

(72) Inventors: Lital Koren, Ness Ziona (IL); Yohai Dayagi, Hanegev (IL); Yaakov Mines, Beer Sheva (IL)

(73) Assignee: Adama Makhteshim Ltd., Beer Sheva (IL)

(21) Appl. No.: 18/570,401

(22) PCT Filed: Jun. 15, 2022
(86) PCT No.: PCT/IB2022/055552

§ 371 Date: Dec. 14, 2023

Related U.S. Application Data
(60) Provisional application No. 63/211,391, filed on Jun. 16, 2021.

(51) Int. Cl. A01N 25/30; A01N 25/04; A01N 47/34; A01P 7/04

(52) U.S. Cl. CPC A01N 25/30; A01N 25/04; A01N 47/34; A01P 7/04

(57) ABSTRACT

The present invention relates to combination of novaluron and an organo-silicone based surfactant, preferably as a suspension or as a water dispersible solid composition. The present invention also provides methods of use of the combinations, including suspensions and compositions, disclosed herein and processes of preparing the combinations, including suspensions and compositions, disclosed herein.

Throughout this application various publications are referenced. The disclosures of these documents in their entireties are hereby incorporated by reference into this application in order to more fully describe the state of the art to which this invention pertains.

### TECHNICAL FIELD

The present invention relates to a combination comprising novaluron and an organo-silicone based surfactant, which may be in the form of a mixture, including tank mix, or a water dispersible solid composition. The present invention also provides methods of use of the combination and compositions disclosed herein and processes of preparing the compositions disclosed herein.

### BACKGROUND

Novaluron, (±)-1-[3-chloro-4-(1,1,2-trifluoro-2-trifluoromethoxyethoxy)phenyl]-3-(2,6-difluorobenzoyl)urea, is used as insect growth regulators (IGR). The most commonly used formulations for solid water insoluble pesticides are suspension concentrates, emulsifiable concentrate and emulsion in water formulations which are liquid formulations and where the pesticide is dissolved in organic carrier.

A water dispersible granular (WDG) formulation which is a solid formulation that generally incorporates the active ingredient into a granule, presents advantages in terms of storage as well as in terms of handling and safety. WDG formulation requires sufficient wetting in water for forming a dispersible aqueous composition for application.

Novaluron is solid at ambient temperature, has an extremely low water solubility and very low wettability. Accordingly, the commercial products containing novaluron as active ingredient are commonly sold as suspension concentrates (SC) or emulsifiable concentrate (EC) formulations. Novaluron formulated as water dispersible granule is disclosed in WO2003/049540. In WO2003/049540, the water dispersible granule composition is prepared by absorbing the active ingredient in liquid form or solution, into an absorbent water dispersible granule prepared from filler particles in a finely divided state and a dispersing agent. The active ingredient, benzoylphenyl urea, in accordance with the invention of WO2003/049540 needs to be in a liquid state or formed into a liquid state, by for example dissolution in a suitable solvent or non-volatile compatible material, such as vegetable or mineral oils or in the form of a suspension or emulsion.

The above-mentioned compositions, which have different drawbacks such as loading limitation, handling and safety, left a need to develop a new composition of novaluron.

### SUMMARY OF THE INVENTION

The present invention provides a combination of novaluron and organo-silicone based surfactant.

In some embodiments, the combination is a mixture comprising (i) solid particles of novaluron, (ii) organo-silicone based surfactant, and (iii) water, wherein the solid particles of novaluron are dispersed in water.

In some embodiments, the combination is a water dispersible solid composition comprising (i) novaluron and (ii) an organo-silicone based surfactant.

The present invention also provides a water dispersible solid composition comprising:
a. novaluron in amount of about 80% w/w based on the total weight of the composition,
b. organo-silicone based surfactant in amount of about 1.5% w/w based on the total weight of the composition,
c. dispersing agent(s) in amount of about 9% w/w based on the total weight of the composition,
d. wetting agent in amount of about 3% w/w based on the total weight of the composition, and
e. agriculturally acceptable solid additive in amount of about 6.5% w/w based on the total weight of the composition.

The present invention also provides a water dispersible solid composition comprising novaluron. The present invention also provides a water dispersible solid composition comprising novaluron and an organo-silicone based surfactant.

The present invention also provides a suspension prepared using any one of the combination or water dispersible solid composition disclosed herein.

The present invention also provides a method for controlling unwanted insects comprising applying an effective amount of the combination, composition or suspension disclosed herein to a plant, a locus thereof, propagation material thereof, or an area infested with the unwanted insects so as to thereby control the unwanted insects.

The present invention also provides a method for controlling plant disease caused by unwanted insect comprising applying an effective amount of the combination, composition or suspension disclosed herein to a plant, a locus thereof, propagation material thereof, or an area infested with the unwanted insect so as to thereby control the plant disease caused by unwanted insect.

The present invention also provides a method for controlling unwanted insects comprising (1) obtaining a suspension comprising novaluron and an organo-silicone based surfactant, and (2) contacting a plant, a locus thereof, propagation material thereof, or an area infested with the unwanted insects with an effective amount of the suspension so as to thereby control the unwanted insects.

The present invention also provides a method for controlling plant disease caused by unwanted insect, comprising (1) obtaining a suspension comprising novaluron and an organo-silicone based surfactant, and (2) contacting a plant, a locus thereof, propagation material thereof, or an area infested with the unwanted insects with an effective amount of the suspension so as to thereby control the plant disease.

The present invention also provides a process for preparing a water dispersible solid composition comprising novaluron, the process comprising (1) mixing novaluron in solid form with at least one agriculturally acceptable additive in solid form to prepare a pre-mix, (2) milling the premix of step (1) to prepare a milled blend, (3) wetting the milled blend with a wetting liquid, (4) perform wet granulation and drying.

The present invention also provides a process for preparing a suspension comprising (i) solid particles of novaluron, (ii) organo-silicone based surfactant, and (iii) water, wherein the solid particles of novaluron are dispersed in water, comprising:
a. mixing (a) a water dispersible solid composition comprising novaluron and an organo-silicone based surfactant, and (b) water, or
b. mixing (a) a water dispersible solid composition comprising novaluron, (b) an organo-silicone based surfactant, and (c) water.

The present invention also provides a suspension prepared using the process disclosed herein.

The present invention also provides a package comprising a water dispersible solid composition comprising (a) novaluron and (b) an organo-silicone based surfactant.

The present invention also provides a package comprising (a) a water dispersible solid composition comprising novaluron, and (b) an organo-silicone based surfactant, wherein the water dispersible solid composition is substantially free or free of organo-silicone based surfactant.

The present invention also provides a package comprising (a) a water dispersible solid composition comprising novaluron, and (b) an organo-silicone based surfactant, wherein the water dispersible solid composition comprises an organo-silicone based surfactant.

The present invention also provides use of an organo-silicone based surfactant for dispersing novaluron in the form of solid particles in water.

The present invention also provides use of novaluron in the form of solid particles for controlling unwanted insects or disease caused by unwanted insects affecting pesticide sensitive crop.

The present invention provides a suspension comprising novaluron in the form of solid particles for controlling insects in the vicinity of pesticide sensitive crop.

### BRIEF DESCRIPTION OF THE DRAWINGS

FIG. 1. Efficacy (mortality %) of the novaluron composition towards Spodoptera Littorals 2nd instar larvae.

FIG. 2. Visual chlorosis results in pepper crop, A-G. (A) nontreated, controlled; (B) and (C), treated with novaluron 10 EC composition; (D) and (E), treated with novaluron 800 WDG-02 composition; (F) and (G), treated with novaluron 800 WDG-03 composition.

### DETAILED DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter belongs.

As used herein, the term “tank mix” means at least two of the components of the combination, mixture or composition of the present invention are mixed in a tank.

As used herein, the term “effective amount” refers to an amount of the novaluron, which when ingested, contacted with or sensed, is sufficient to achieve a good level of control.

As used herein, an “agriculturally acceptable additive” is a compound that is known and accepted in the art for use in the formation of solid compositions for agricultural or horticultural use.

As used herein, the term “adjuvant” is defined as any substance that is not an active ingredient but which enhances or is intended to enhance the effectiveness of the active ingredient, for example pesticide, with which it is used. Adjuvants may include, but are not limited to, spreading agents, penetrants, compatibility agents, and drift retardants.

As used herein, the term “concentrated” refers to the solid composition before mixing with water.

As used herein, the term “tank sprayer” means the tank where the composition is added to water before use, at the time of spray application.

As used herein, the term “plant” includes reference to the whole plant, plant organ (e.g., leaves, stems, twigs, roots, trunks, limbs, shoots, fruits etc.), or plant cells.

As used herein, the term “plant” includes reference to agricultural crops including field crops (soybean, maize, wheat, rice, etc.), vegetable crops (potatoes, cabbages, etc.) and fruits (peach, etc.).

As used herein, the term “propagation material” is to be understood to denote all the generative parts of the plant such as seeds and spores, vegetative structures such as bulbs, corms, tubers, rhizomes, roots stems, basal shoots, stolons and buds.

As used herein, the term “locus” includes not only areas where insect may already exist, but also areas where insect has yet to emerge, and also to areas under cultivation.

As used herein the term “knockdown treatment” or “knockdown activity” means an application of one or more insecticide for controlling insect infestation of the plant or locus before and/or after an infestation or before and/or after insect damage are shown and/or when the pest pressure is low/high. Insect pressure may be assessed based on the conditions associated with insect development such as population density and certain environmental conditions.

As used herein the term “persistence treatment” or “persistence activity” is used in connection with an insecticide, the term means an application of one or more insecticide for controlling insect infestation of the plant or locus over an extended period of time, before and/or after an infestation or before and/or after insect damage are shown and/or when the insect pressure is low/high. Insect pressure may be assessed based on the conditions associated with insect development such as population density and certain environmental conditions.

As used herein, the term “ha” refers to hectare.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”: however, it will be understood by one of skill in the art, that in some specific instances, an embodiment can alternatively be described using the language “consisting essentially of” or “consisting of.”

The term “about” as used herein specifically includes ±10% from the indicated values in the range. In addition, the endpoints of all ranges directed to the same component or property herein are inclusive of the endpoints, are independently combinable, and include all intermediate points and ranges. It is understood that where a parameter range is provided, all integers within that range, and tenths thereof, are also provided by the invention. For example, “10-50%” includes 10%, 10.1%, 10.2%, etc. up to 50%.

As used herein, the term “water dispersible solid composition” refers to a solid composition comprising two or more components formulated to disperse at least one component of the composition in the form of solid particles when mixed with water.

In some embodiments, at least one of the components dispersed in the form of solid particles is the active ingredient.

In some embodiments, the solid particles have a particle size distribution d90 of less than 30 microns. In some embodiments, the solid particles have a particle size distribution d90 of less than 20 microns.

Dispersing a solid composition comprising novaluron in water, in form of solid particles, and in particular a high load solid composition, is challenging especially after storage (14 days at 54° C.

Solid composition prepared in standard method with commonly used dispersing agents and wetting agents suffered from instability of the dispersion and accumulation of solid novaluron at the water air interface upon dilution.

Fresh novaluron granules which are prepared with commonly used dispersing agents and wetting agents may be wetted and/or dispersed in acceptable range before any storage but a decrease in wettability and/or suspensibility after storage of 14 days at 54° C. is observed.

It was found that the organo-silicone based surfactant stabilizes the granules and reduces deterioration in wettability and/or suspensibility after storage (14 days at 54° C.).

It was found that novaluron can be formulated as a water dispersible solid composition which is disintegrates and disperses rapidly in water wherein the novaluron disperses in water in solid form, when at least one organo-silicone based surfactant is used as a component of the water dispersible solid composition and/or added to the tank mix.

Adding organo-silicone based surfactant to solid composition of novaluron prevents the floating of novaluron and allows to obtain a stable dispersion.

Using organo-silicone based surfactant in combination with at least one additional wetting agent and at least one dispersing agent leads to complete disintegration and stable dispersion of novaluron solid particles in water.

It was found that a combination of two wetting agents, wherein at least one is organo-silicone based surfactant provides an efficient wetting rate and stable dispersion in water.

In addition, it was found that novaluron, when applied in form of solid particles dispersed in water, provides safe and efficient treatment in pesticide sensitive crops.

### Combination of Novaluron Solid Particles and Organo-Silicone Based Surfactant

The present invention provides a combination of novaluron and organo-silicone based surfactant.

In some embodiments, the combination is a mixture comprising (i) solid particles of novaluron, (ii) organo-silicone based surfactant, and (iii) water, wherein the solid particles of novaluron are dispersed in water.

In some embodiments, the mixture is a suspension. In some embodiments, the suspension is an aqueous suspension. In some embodiments, the combination is prepared by mixing a water dispersible solid composition comprising novaluron described herein with water. Accordingly, the combination may comprise any component used to formulate the water dispersible solid composition. Components of the water dispersible solid composition include novaluron, organo-silicone bases surfactant and agriculturally acceptable additive. Agriculturally acceptable additives include, but are not limited to, dispersing agent(s), wetting agent(s), filler(s), binder(s), anti-foaming agent(s), biocide(s), water absorbent(s), water scavenger(s), adjuvant(s) and any combination thereof. Preferred agriculturally acceptable additives that may be used for formulate the water dispersible solid composition of the present invention are described herein.

In some embodiments, the water dispersible solid composition comprising novaluron further comprises an organo-silicone based surfactant.

In some embodiments, the mixture is a tank mix. The tank mix may be prepared by mixing water with the water dispersible solid composition comprising novaluron and the organo-silicone based surfactant. The tank mix may also be prepared by mixing water with the water dispersible solid composition comprising novaluron and separately adding the organo-silicone based surfactant. The water dispersible solid composition comprising novaluron may be free of organo-silicone based surfactant. The organo-silicone based surfactant may be added to the tank mix before, during or after the addition of the water dispersible solid composition comprising novaluron.

In some embodiments, the solid particles of novaluron have a particle size distribution D90 of 20 microns or less. In some embodiments, the solid particles of novaluron have a particle size distribution D95 of 20 microns or less. In some embodiments, the solid particles of novaluron have a particle size distribution D99 of 20 microns or less. In some embodiments, all of the solid particles of novaluron have a particle size of 20 microns or less.

In some embodiments, the solid particles of novaluron have particle sizes between 5 to 20 microns. In some embodiments, the solid particles of novaluron have particle sizes between 6 to 20 microns. In some embodiments, the solid particles of novaluron have particle sizes between 7 to 20 microns. In some embodiments, the solid particles of novaluron have particle sizes between 10 to 20 microns.

In some embodiments, the solid particles of novaluron have a particle size distribution D90 of 30 microns or less. In some embodiments, the solid particles of novaluron have a particle size distribution D90 of 25 microns or less. In some embodiments, the solid particles of novaluron have a particle size distribution D90 of 20 microns or less.

In some embodiments, the solid particles of novaluron have a particle size distribution D95 of 35 microns or less. In some embodiments, the solid particles of novaluron have a particle size distribution D95 of 20 microns or less. In some embodiments, the solid particles of novaluron have a particle size distribution D99 of 40 microns or less. In some embodiments, the solid particles of novaluron have a particle size distribution D99 of 20 microns or less.

In some embodiments, all of the solid particles of novaluron have a particle size of 45 microns or less. In some embodiments, all of the solid particles of novaluron have a particle size of 20 microns or less.

In some embodiments, the solid particles of novaluron have a particle size distribution D90 between 5 to 20 micron. In some embodiments, the solid particles of novaluron have a particle size distribution D90 between 6 to 20 micron. In some embodiments, the solid particles of novaluron have a particle size distribution D90 between 7 to 20 micron. In some embodiments, the solid particles of novaluron have a particle size distribution D90 between 10 to 20 micron.

In some embodiments, the solid particles of novaluron have a particle size distribution D95 between 5 to 35 micron. In some embodiments, the solid particles of novaluron have a particle size distribution D95 between 5 to 20 micron. In some embodiments, the solid particles of novaluron have a particle size distribution D95 between 6 to 35 micron. In some embodiments, the solid particles of novaluron have a particle size distribution D95 between 6 to 20 micron. In some embodiments, the solid particles of novaluron have a particle size distribution D95 between 7 to 35 micron. In some embodiments, the solid particles of novaluron have a particle size distribution D95 between 7 to 20 micron. In some embodiments, the solid particles of novaluron have a particle size distribution D95 between 10 to 20 micron.

In some embodiments, the solid particles of novaluron have a particle size distribution D95 between 5 to 40 micron. In some embodiments, the solid particles of novaluron have a particle size distribution D99 between 5 to 20 micron. In some embodiments, the solid particles of novaluron have a particle size distribution D95 between 6 to 40 micron. In some embodiments, the solid particles of novaluron have a particle size distribution D99 between 6 to 20 micron. In some embodiments, the solid particles of novaluron have a particle size distribution D95 between 7 to 40 micron. In some embodiments, the solid particles of novaluron have a particle size distribution D99 between 7 to 20 micron. In some embodiments, the solid particles of novaluron have a particle size distribution D99 between 10 to 20 micron.

In some embodiments, all of the solid particles of novaluron have a particle size between 5 to 45 micron. In some embodiments, all of the solid particles of novaluron have a particle size between 5 to 20 micron. In some embodiments, all of the solid particles of novaluron have a particle size between 6 to 45 micron. In some embodiments, all of the solid particles of novaluron have a particle size between 6 to 20 micron. In some embodiments, all of the solid particles of novaluron have a particle size between 7 to 45 micron. In some embodiments, all of the solid particles of novaluron have a particle size between 7 to 20 micron. In some embodiments, all of the solid particles of novaluron have a particle size between 10 to 20 micron.

When the combination is prepared by mixing the water dispersible solid composition comprising novaluron described herein with water, the combination will comprise components used to formulate the water dispersible solid composition, including agriculturally acceptable additive(s) used to formulate the water dispersible solid composition, including, but not limited to, dispersing agent(s), wetting agent(s), filler(s), binder(s), anti-foaming agent(s), biocide(s), water absorbent(s), water scavenger(s), adjuvant(s) and any combination thereof. Once the water dispersible solid composition is mixed with water, these agriculturally acceptable additive(s) may be dissolved in the water or dispersed in the form of solid particles in the water.

In some embodiments, agriculturally acceptable additive is a compound that is known and accepted in the art for use in the formation of solid compositions for agricultural or horticultural use.

The components of the water dispersible solid composition that disperse in the water to form solid particles have small particle sizes.

In some embodiments, solid particles of all components of the water dispersible solid composition that form solid particles in water have a particle size distribution D90 of 30 microns or less. In some embodiments, solid particles of all components of the water dispersible solid composition that form solid particles in water have a particle size distribution D90 of 25 microns or less. In some embodiments, solid particles of all components of the water dispersible solid composition that form solid particles in water have a particle size distribution D90 of 20 microns or less.

In some embodiments, solid particles of all components of the water dispersible solid composition that form solid particles in water have a particle size distribution D95 of 35 microns or less. In some embodiments, solid particles of all components of the water dispersible solid composition that form solid particles in water have a particle size distribution D95 of 20 microns or less.

In some embodiments, solid particles of all components of the water dispersible solid composition that form solid particles in water have a particle size distribution D99 of 40 microns or less. In some embodiments, solid particles of all components of the water dispersible solid composition that form solid particles in water have a particle size distribution D99 of 20 microns or less.

In some embodiments, solid particles of all components of the water dispersible solid composition that form solid particles in water have a particle size of 45 microns or less. In some embodiments, solid particles of all components of the water dispersible solid composition that form solid particles in water have a particle size of 20 microns or less.

In some embodiments, solid particles of all components of the water dispersible solid composition that form solid particles in water have particle sizes between 5 to 20 microns. In some embodiments, solid particles of all components of the water dispersible solid composition that form solid particles in water have particle sizes between 6 to 20 microns. In some embodiments, solid particles of all components of the water dispersible solid composition that form solid particles in water have particle sizes between 7 to 20 microns. In some embodiments, solid particles of all components of the water dispersible solid composition that form solid particles in water have particle sizes between 10 to 20 microns.

In some embodiments, solid particles of all components of the water dispersible solid composition that form solid particles in water have a particle size distribution D90 between 5 to 30 microns. In some embodiments, solid particles of all components of the water dispersible solid composition that form solid particles in water have a particle size distribution D90 between 5 to 20 microns. In some embodiments, solid particles of all components of the water dispersible solid composition that form solid particles in water have a particle size distribution D90 between 6 to 30 microns. In some embodiments, solid particles of all components of the water dispersible solid composition that form solid particles in water have a particle size distribution D90 between 6 to 20 microns. In some embodiments, solid particles of all components of the water dispersible solid composition that form solid particles in water have a particle size distribution D90 between 7 to 30 microns. In some embodiments, solid particles of all components of the water dispersible solid composition that form solid particles in water have a particle size distribution D90 between 7 to 20 microns. In some embodiments, solid particles of all components of the water dispersible solid composition that form solid particles in water have a particle size distribution D90 between 10 to 20 microns.

In some embodiments, solid particles of all components of the water dispersible solid composition that form solid particles in water have a particle size distribution D95 between 5 to 35 microns. In some embodiments, solid particles of all components of the water dispersible solid composition that form solid particles in water have a particle size distribution D95 between 5 to 20 microns. In some embodiments, solid particles of all components of the water dispersible solid composition that form solid particles in water have a particle size distribution D95 between 6 to 35 microns. In some embodiments, solid particles of all components of the water dispersible solid composition that form solid particles in water have a particle size distribution D95 between 6 to 20 microns. In some embodiments, solid particles of all components of the water dispersible solid composition that form solid particles in water have a particle size distribution D95 between 7 to 35 microns. In some embodiments, solid particles of all components of the water dispersible solid composition that form solid particles in water have a particle size distribution D95 between 7 to 20 microns. In some embodiments, solid particles of all components of the water dispersible solid composition that form solid particles in water have a particle size distribution D95 between 10 to 20 microns.

In some embodiments, solid particles of all components of the water dispersible solid composition that form solid particles in water have a particle size distribution D99 between 5 to 40 microns. In some embodiments, solid particles of all components of the water dispersible solid composition that form solid particles in water have a particle size distribution D99 between 5 to 20 microns. In some embodiments, solid particles of all components of the water dispersible solid composition that form solid particles in water have a particle size distribution D99 between 6 to 40 microns. In some embodiments, solid particles of all components of the water dispersible solid composition that form solid particles in water have a particle size distribution D99 between 6 to 20 microns. In some embodiments, solid particles of all components of the water dispersible solid composition that form solid particles in water have a particle size distribution D99 between 7 to 40 microns. In some embodiments, solid particles of all components of the water dispersible solid composition that form solid particles in water have a particle size distribution D99 between 7 to 20 microns. In some embodiments, solid particles of all components of the water dispersible solid composition that form solid particles in water have a particle size distribution D99 between 10 to 20 microns.

In some embodiments, solid particles of all components of the water dispersible solid composition that form solid particles in water have a particle size between 5 to 45 microns. In some embodiments, solid particles of all components of the water dispersible solid composition that form solid particles in water have a particle size between 5 to 20 microns. In some embodiments, solid particles of all components of the water dispersible solid composition that form solid particles in water have a particle size between 6 to 45 microns. In some embodiments, solid particles of all components of the water dispersible solid composition that form solid particles in water have a particle size between 6 to 20 microns. In some embodiments, solid particles of all components of the water dispersible solid composition that form solid particles in water have a particle size between 7 to 45 microns. In some embodiments, solid particles of all components of the water dispersible solid composition that form solid particles in water have a particle size between 7 to 20 microns. In some embodiments, solid particles of all components of the water dispersible solid composition that form solid particles in water have a particle size between 10 to 20 microns.

In some embodiments, the component in the form of solid particles is an agriculturally acceptable additive.

In some embodiments, the combination is a water dispersible solid composition comprising (i) novaluron and (ii) an organo-silicone based surfactant.

In some embodiments, the water dispersible solid composition is a ready-mix water dispersible solid composition. In some embodiments, ready-mix refers to a concentrated composition which comprises the combination components formulated together in one composition.

In some embodiments, the combination comprises (i) a water dispersible solid composition comprising novaluron, and (ii) an organo-silicone based surfactant.

In some embodiments, the water dispersible solid composition is a granular composition.

In some embodiments, the granular composition is in the form of wettable granules.

In some embodiments, mixing with water refers to adding water to the combination and/or composition. In some embodiments, mixing with water refers to adding the combination and/or composition into the water.

In some embodiments, the water dispersible solid composition comprising novaluron is mixed with the water before the organo-silicone based surfactant is mixed with water. In some embodiments, the organo-silicone based surfactant is mixed with water before the water dispersible solid composition comprising novaluron is mixed with water.

In some embodiments, the water dispersible solid composition comprising novaluron, when used for tank mix, is free of the organo-silicone based surfactant.

In some embodiments, the water dispersible solid composition is a water dispersible granular solid composition.

In some embodiments, the solid composition is granular composition.

In some embodiment, the solid composition is powder composition.

In some embodiment, the organo-silicone based surfactant is an organo-modified tri-siloxane.

The organo-modified tri-siloxane may be, but is not limited to, Silwet® L77, Silwet 806, BREAK-THRU® S 240, or any combination thereof.

In some embodiments, the organo-modified tri-siloxane is selected from the group consisting of Silwet® L77, Silwet® 806, BREAK-THRU® S 240 and any combination thereof.

In some embodiments, the organo-modified tri-siloxane is selected from the group consisting of Silwet® L77, Silwet® 806, BREAK-THRU® S 240 and any combination thereof.

In some embodiments, the organo-silicone based surfactant has the following structure:

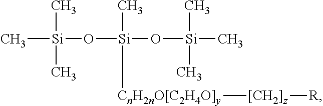

wherein n=1-4, y=3-10, z=0-5, and R is an alkyl having 1-4 carbon atoms or H or OH.

In some embodiments, the organo-silicone based surfactant is Silwet® L77.

In some embodiments, the organo-silicone based surfactant is 3-(8-methoxy octoxy)propyl-methyl-bis(trimethylsilyloxy)silane.

In some embodiments, the weight ratio between the organo-silicone based surfactant and the novaluron in the combination is 50:1 to 1:100.

In some embodiments, when the combination is a water dispersible solid composition, the weight ratio between the organo-silicone based surfactant and the novaluron in the combination is between 1:100 to 5.5:100. In some embodiments, when the combination is a water dispersible solid composition, the weight ratio between the organo-silicone based surfactant and the novaluron in the combination is between 1:30 to 1:70. In some embodiments, when the combination is a water dispersible solid composition, the weight ratio between the organo-silicone based surfactant and the novaluron in the combination is between 1:40 to 1:60. In some embodiments, when the combination is a water dispersible solid composition, the weight ratio between the organo-silicone based surfactant and the novaluron in the combination is between 1:50 to 1:55. In some embodiments, when the combination is a water dispersible solid composition, the weight ratio between the organo-silicone based surfactant and the novaluron in the combination is about 1.5:80.

In some embodiments, when the combination is a suspension, the weight ratio between the organo-silicone based surfactant to the novaluron in the combination is between 1:2 to 50:1.

In some embodiments, when the organo-silicone based surfactant and the novaluron are combined as tank mix, the weight ratio between the organo-silicone based surfactant to the novaluron in the combination is between 1:2 to 50:1.

The present invention provides a combination of an amount of novaluron and an amount of organo-silicone based surfactant, wherein the novaluron is formulated in the form of water dispersible solid composition.

The present invention provides a combination of an amount of novaluron and an amount of organo-silicone based surfactant, wherein the novaluron is formulated in the form of water dispersible solid composition, and when the combination is mixed with water the novaluron is dispersed in the water in form of solid particles.

The present invention provides a combination of an amount of novaluron and an amount of organo-silicone based surfactant, wherein the novaluron and the organo-silicone based surfactant are formulated in the form of a water dispersible solid composition, and when the composition is mixed with water the novaluron is dispersed in water in form of solid particles.

The present invention provides a combination of novaluron in solid form and organo-silicone based surfactant, wherein the novaluron is formulated in the form of a water dispersible solid composition.

The present invention provides a combination an amount of organo-silicone based surfactant and water dispersible solid composition comprising an amount of novaluron, wherein when the combination is mixed with water, the novaluron is dispersed in water in the form of solid particles.

In some embodiments, the combination is formulated together as ready-mix water dispersible solid composition.

In some embodiments, the combination is formulated in two compositions.

In some embodiments, the combination is mixing a water dispersible solid composition of novaluron with organo-silicone based surfactant.

In some embodiments, the novaluron is dispersed in water in form of solid particles.

In some embodiments, the combination is as tank mix.

In some embodiments, when the combination of the present invention is provided as tank mix, the novaluron may be formulated in the form of water dispersible solid composition free of the organo-silicone based surfactant and the organo-silicone based surfactant is added separately.

In some embodiments, the organo-silicone based surfactant is combined with the water dispersible solid composition comprising novaluron as tank mix.

In some embodiments, when the organo-silicone based surfactant is combined with water dispersible solid composition comprising novaluron as tank mix, the weight ratio of the organo-silicone based surfactant to novaluron is between 1:2 to 50:1.

In some embodiments, the organo-silicone based surfactant is used as tank mix, and the weight ratio of organo-silicone based surfactant to novaluron is between 1:2 to 50:1.

In some embodiments, mixed with water refers to adding water to the combination and/or composition.

In some embodiments, mixed with water refers to adding the combination and/or composition into the water.

In some embodiments, mixed with water refers to adding water to the organo-silicone based surfactant and/or adding the organo-silicone based surfactant into the water prior to mixing with the water dispersible solid composition of novaluron.

In some embodiments, mixed with water refers to adding water to the water dispersible solid composition of novaluron and/or adding the water dispersible solid composition of novaluron into the water prior to mixing with organo-silicone based surfactant.

In some embodiments, the combination is a water dispersible solid composition comprising (i) novaluron and (ii) an organo-silicone based surfactant.

In some embodiments, the combination is (1) a water dispersible solid composition comprising novaluron and (2) an organo-silicone based surfactant.

In some embodiments, the water dispersible solid composition comprises novaluron, when used for tank mix is free of the organo-silicone based surfactant.

### Water Dispersible Solid Compositions

The present invention provides a water dispersible solid composition, particularly a high load composition comprising novaluron that possess proper wetting, dispersibility and dispersion stability as well as no chlorosis.

The water dispersible solid composition of the present invention exhibits proper dispersion stability with no floating particles at the air water interface.

The ready-mix water dispersible solid compositions of the present invention undergo spontaneous dispersion when mixed with water in the tank sprayer before application to the plant.

The present invention provides a water dispersible solid composition comprising novaluron.

The present invention provides a water dispersible solid composition comprising novaluron wherein the novaluron used for preparing the composition is in solid form.

The present invention provides a water dispersible solid composition comprising an amount of novaluron and an amount of organo-silicone based surfactant.

The present invention provides a water dispersible solid composition comprising an amount of novaluron and an amount of organo-silicone based surfactant, wherein the novaluron is dispersed in water in the form of solid particles when the composition is mixed with water.

In some embodiments, the water dispersible solid composition comprises an organo-silicone based surfactant. The organo-silicone based surfactant can be combined with the novaluron during the composition formation, in the granulation process, and/or during the water dilution process of the composition.

The present invention provides a water dispersible solid composition comprising novaluron and an organo-silicone based surfactant.

In some embodiments, the water dispersible solid composition is a ready-mix water dispersible solid composition.

In some embodiments, the water dispersible solid composition, upon dilution in water, produces the physically stable aqueous suspension composition disclosed herein.

In some embodiments, the water dispersible solid composition is a solid, wettable, rapidly disintegrating dispersible composition. In some embodiments, less than 20 inversions of a container comprising the water dispersible solid composition and water is needed disintegrate the water dispersible solid composition and completely suspend the novaluron in a stable suspension according to disintegration test methods as disclosed in the appended description and/or under CIPAC Test MT 174.

In some embodiments, the number of inversions required remains less than 20 after storage of the water dispersible solid composition at 54° C. for 14 days.

As used herein, the term “water dispersible solid composition” is synonymous with the term “wettable dispersible solid composition”.

The present invention provides wettable dispersible solid composition comprising an amount of novaluron and an amount of organo-silicone based surfactant.

The present invention provides wettable dispersible solid composition comprising an amount of novaluron, wherein the composition is formulated to disperse the novaluron in the form of solid particles when the composition is mixed with water.

In some embodiments, the water dispersible solid composition is formulated to disperse the novaluron in the form of solid particles when mixed with water.

In some embodiments, the water dispersible solid composition is formulated to disperse the novaluron in the form of solid particles having a particle size distribution D90 of 30 microns or less. In some embodiments, the water dispersible solid composition is formulated to disperse the novaluron in the form of solid particles having a particle size distribution D90 of 20 microns or less. In some embodiments, the water dispersible solid composition is formulated to disperse the novaluron in the form of solid particles having a particle size distribution D95 of 35 microns or less. In some embodiments, the water dispersible solid composition is formulated to disperse the novaluron in the form of solid particles having a particle size distribution D95 of 20 microns or less. In some embodiments, the water dispersible solid composition is formulated to disperse the novaluron in the form of solid particles having a particle size distribution D99 of 40 microns or less. In some embodiments, the water dispersible solid composition is formulated to disperse the novaluron in the form of solid particles having a particle size distribution D99 of 20 microns or less. In some embodiments, the water dispersible solid composition is formulated to disperse the novaluron in the form of solid particles all having a particle size of 45 microns or less. In some embodiments, the water dispersible solid composition is formulated to disperse the novaluron in the form of solid particles having a particle size of 20 microns or less.

In some embodiments, the water dispersible solid composition is formulated to disperse the novaluron in the form of solid particles having particle sizes between 5 to 30 microns. In some embodiments, the water dispersible solid composition is formulated to disperse the novaluron in the form of solid particles having particle sizes between 5 to 20 microns. In some embodiments, the water dispersible solid composition is formulated to disperse the novaluron in the form of solid particles having particle sizes between 6 to 30 microns. In some embodiments, the water dispersible solid composition is formulated to disperse the novaluron in the form of solid particles having particle sizes between 6 to 20 microns. In some embodiments, the water dispersible solid composition is formulated to disperse the novaluron in the form of solid particles having particle sizes between 7 to 30 microns. In some embodiments, the water dispersible solid composition is formulated to disperse the novaluron in the form of solid particles having particle sizes between 7 to 20 microns. In some embodiments, the water dispersible solid composition is formulated to disperse the novaluron in the form of solid particles having particle sizes between 10 to 20 microns.

In some embodiments, the water dispersible solid composition is formulated to disperse the novaluron in the form of solid particles having a particle size distribution D90 between 5 to 30 microns. In some embodiments, the water dispersible solid composition is formulated to disperse the novaluron in the form of solid particles having a particle size distribution D90 between 5 to 20 microns. In some embodiments, the water dispersible solid composition is formulated to disperse the novaluron in the form of solid particles having a particle size distribution D90 between 6 to 30 microns. In some embodiments, the water dispersible solid composition is formulated to disperse the novaluron in the form of solid particles having a particle size distribution D90 between 6 to 20 microns. In some embodiments, the water dispersible solid composition is formulated to disperse the novaluron in the form of solid particles having a particle size distribution D90 between 7 to 30 microns. In some embodiments, the water dispersible solid composition is formulated to disperse the novaluron in the form of solid particles having a particle size distribution D90 between 7 to 20 microns. In some embodiments, the water dispersible solid composition is formulated to disperse the novaluron in the form of solid particles having a particle size distribution D90 between 10 to 20 microns.

In some embodiments, the water dispersible solid composition is formulated to disperse the novaluron in the form of solid particles having a particle size distribution D95 between 5 to 35 microns. In some embodiments, the water dispersible solid composition is formulated to disperse the novaluron in the form of solid particles having a particle size distribution D95 between 5 to 20 microns. In some embodiments, the water dispersible solid composition is formulated to disperse the novaluron in the form of solid particles having a particle size distribution D95 between 6 to 35 microns. In some embodiments, the water dispersible solid composition is formulated to disperse the novaluron in the form of solid particles having a particle size distribution D95 between 6 to 20 microns. In some embodiments, the water dispersible solid composition is formulated to disperse the novaluron in the form of solid particles having a particle size distribution D95 between 7 to 35 microns. In some embodiments, the water dispersible solid composition is formulated to disperse the novaluron in the form of solid particles having a particle size distribution D95 between 7 to 20 microns. In some embodiments, the water dispersible solid composition is formulated to disperse the novaluron in the form of solid particles having a particle size distribution D95 between 10 to 20 microns.

In some embodiments, the water dispersible solid composition is formulated to disperse the novaluron in the form of solid particles having a particle size distribution D99 between 5 to 40 microns. In some embodiments, the water dispersible solid composition is formulated to disperse the novaluron in the form of solid particles having a particle size distribution D99 between 5 to 20 microns. In some embodiments, the water dispersible solid composition is formulated to disperse the novaluron in the form of solid particles having a particle size distribution D99 between 6 to 40 microns. In some embodiments, the water dispersible solid composition is formulated to disperse the novaluron in the form of solid particles having a particle size distribution D99 between 6 to 20 microns. In some embodiments, the water dispersible solid composition is formulated to disperse the novaluron in the form of solid particles having a particle size distribution D99 between 7 to 40 microns. In some embodiments, the water dispersible solid composition is formulated to disperse the novaluron in the form of solid particles having a particle size distribution D99 between 7 to 20 microns. In some embodiments, the water dispersible solid composition is formulated to disperse the novaluron in the form of solid particles having a particle size distribution D99 between 10 to 20 microns.

In some embodiments, the water dispersible solid composition is formulated to disperse the novaluron in the form of solid particles all having a particle size between 5 to 45 microns. In some embodiments, the water dispersible solid composition is formulated to disperse the novaluron in the form of solid particles all having a particle size between 5 to 20 microns. In some embodiments, the water dispersible solid composition is formulated to disperse the novaluron in the form of solid particles all having a particle size between 6 to 45 microns. In some embodiments, the water dispersible solid composition is formulated to disperse the novaluron in the form of solid particles all having a particle size between 6 to 20 microns. In some embodiments, the water dispersible solid composition is formulated to disperse the novaluron in the form of solid particles all having a particle size between 7 to 45 microns. In some embodiments, the water dispersible solid composition is formulated to disperse the novaluron in the form of solid particles all having a particle size between 7 to 20 microns. In some embodiments, the water dispersible solid composition is formulated to disperse the novaluron in the form of solid particles all having a particle size between 10 to 20 microns.

Particle size affects the physical stability, dispersion quality of the novaluron solid particles and maintains the biological activity of the novaluron.

In some embodiments, the amount of novaluron in the water dispersible solid composition is between about 10% to about 95% w/w based on the total weight of the composition. In some embodiments, the amount of novaluron in the water dispersible solid composition is between about 10% to about 90% w/w based on the total weight of the composition. In some embodiments, the amount of novaluron in the water dispersible solid composition is between about 40% to about 85% w/w based on the total weight of the composition. In some embodiments, the amount of novaluron in the water dispersible solid composition is between about 70% to about 80% w/w based on the total weight of the composition. In some embodiments, the amount of novaluron in the water dispersible solid composition is between about 75% to about 85% w/w based on the total weight of the composition. In some embodiments, the amount of novaluron in the water dispersible solid composition is about 80% w/w based on the total weight of the composition.

In some embodiments, the water dispersible solid composition is high-load.

In some embodiments, high-load refers to composition contains an amount of active ingredients greater than 50% w/w based on the total weight of the composition.

In some embodiments, the amount of novaluron in the water dispersible solid composition is at least 50% w/w based on the total weight of the composition. In some embodiments, the amount of novaluron in the water dispersible solid composition is at least 70% w/w based on the total weight of the composition. In some embodiments, the amount of novaluron in the water dispersible solid composition is at least 80% w/w based on the total weight of the composition. In some embodiments, the amount of novaluron in the water dispersible solid composition is about 80% w/w based on the total weight of the composition.

In some embodiments, the amount of novaluron in the water dispersible solid composition is 50-95% w/w based on the total weight of the composition. In some embodiments, the amount of novaluron in the water dispersible solid composition is 50-90% w/w based on the total weight of the composition. In some embodiments, the amount of novaluron in the water dispersible solid composition is 50-85% w/w based on the total weight of the composition.

In some embodiments, the water dispersible solid composition is a granular composition.

In some embodiments, the granular composition is in the form of wettable granules.

In some embodiments, the water dispersible solid composition comprise an organo-silicone based surfactant.

In some embodiment, the organo-silicone based surfactant is organo-modified tri-siloxane.

The organo-modified tri-siloxane may be, but is not limited to, Silwet® L77, Silwet 806, BREAK-THRU® S 240, or any combination thereof.

In some embodiments, the organo-silicone based surfactant has the following structure:

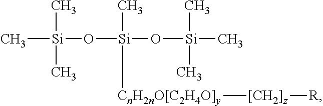

wherein n=1-4, y=3-10, z=0-5, and R is an alkyl having 1-4 carbon atoms or H or OH.

In some embodiments, the organo-silicone based surfactant is Silwet® L77.

In some embodiments, the organo-silicone based surfactant is 3-(8-methoxyoctoxy)propyl-methyl-bis(trimethylsilyloxy)silane.

In some embodiments, the amount of organo-silicone based surfactant in the water dispersible solid composition is between about 0.5% to about 5% w/w based on the total weight of the composition. In some embodiments, the amount of the organo-silicone based surfactant in the water dispersible solid composition is between about 1% to about 3% w/w based on the total weight of the composition. In some embodiments, the amount of organo-silicone based surfactant in the water dispersible solid composition is about 1.5% w/w based on the total weight of the composition.

In some embodiments, the amount of the organo-silicone based surfactant in the ready-mix water dispersible solid composition is between about 0.5% to about 5% w/w based on the total weight of the composition. In some embodiments, the amount of the organo-silicone based surfactant in the ready-mix water dispersible solid composition is between about 1% to about 3% w/w based on the total weight of the composition. In some embodiments, the amount of the organo-silicone based surfactant in the ready-mix water dispersible solid composition is about 1.5% w/w based on the total weight of the composition.

In some embodiments, the weight ratio between the organo-silicone based surfactant and the novaluron in the water dispersible solid composition is between 1:100 to 5.5:100. In some embodiments, the weight ratio between the organo-silicone based surfactant and the novaluron in the water dispersible solid composition is between 1:30 to 1:70. In some embodiments, the weight ratio between the organo-silicone based surfactant and the novaluron in the water dispersible solid composition is between 1:40 to 1:60. In some embodiments, the weight ratio between the organo-silicone based surfactant and the novaluron in the water dispersible solid composition is between 1:50 to 1:55. In some embodiments, the weight ratio between the organo-silicone based surfactant and the novaluron in the water dispersible solid composition is about 1.5:80.

In some embodiments, the water dispersible solid composition comprises at least one agriculturally acceptable additive. In some embodiments, the agriculturally acceptable additive is in solid form.

In some embodiments, the agriculturally acceptable additive is selected from the group consisting of dispersing agent, wetting agent, filler, binder, anti-foaming agent, biocides, water absorbents, water scavengers, adjuvants and any combination thereof. In some embodiments, the agriculturally acceptable additive is selected from the group consisting of dispersing agent, wetting agent, filler, binder, and any combination thereof. In some embodiments, the agriculturally acceptable additive is a dispersing agent. In some embodiments, the agriculturally acceptable additive is a wetting agent. In some embodiments, the agriculturally acceptable additive is a filler. In some embodiments, the agriculturally acceptable additive is a binder.

In some embodiments, the water dispersible solid composition comprises at least one wetting agent.

In some embodiments, the water dispersible solid composition comprises a combination of organo-silicone based surfactant and at least one wetting agent.

In some embodiments, the wetting agent is solid. In some embodiments, the wetting agent is liquid.

In some embodiments, the wetting agent is selected from the group consisting of sodium alkylnaphthalenesulfonate, sodium phenolsulfonic acid, polycondensed formaldehyde, alcohol ethoxylate, sodium lauryl sulfate, polyalkoxylated butyl ether, polyarylphenyl phosphate ether, sodium ducosate, and any combination thereof.

In some embodiments, the wetting agent is sodium alkylnaphthalenesulfonate.

In some embodiments, the sodium alkylnaphthalenesulfonate is Morwet EFW.

In some embodiments, the amount of wetting agent in the water dispersible solid composition is between about 2% to about 5% w/w based on the total weight of the composition. In some embodiments, the amount of wetting agent in the water dispersible solid composition is about 3% w/w based on the total weight of the composition.

In some embodiments, the amount of wetting agent in the water dispersible solid composition is between about 0.01% to about 10% w/w based on the total weight of the composition. In some embodiments, the amount of wetting agent in the water dispersible solid composition is between about 0.1% to about 10% w/w based on the total weight of the composition. In some embodiments, the amount of wetting agent in the water dispersible solid composition is between about 0.01% to about 5% w/w based on the total weight of the composition. In some embodiments, the amount of wetting agent in the water dispersible solid composition is between about 0.01% to about 2.5% w/w based on the total weight of the composition. In some embodiments, the amount of wetting agent in the water dispersible solid composition is between about 0.01% to about 0.5% w/w based on the total weight of the composition.

In some embodiments, the water dispersible solid composition comprises a dispersing agent. In some embodiments, the water dispersible solid composition comprises at least two dispersing agents.

In some embodiment, the water dispersible solid composition comprises a combination of wetting agent and dispersing agent.

In some embodiments, the dispersing agent is solid. In some embodiments, the dispersing agent is liquid.

In some embodiments, the dispersing agent has a polymeric structure.

In some embodiments, the dispersing agent is an ionic compound.

In some embodiment, the dispersing agent is an ionic compound having a polymeric structure.

In some embodiments, the dispersing agent is an anionic compound.

In some embodiment, the dispersing agent is an anionic compound having a polymeric structure.

In some embodiments, the dispersing agent is selected from the group consisting of condensate of alkyl naphthalene sulfonate formaldehyde, methyl naphthalene sulfonate condensate, sodium salt, ethoxylated fatty alcohol, hydrophobically modified polyacrylate, lignosulfonates, polyelectrolyte block copolymer (as described in WO2017/098325) and any combination thereof.

In some embodiments, the dispersing agent is a modified sodium lignosulphonate. In some embodiments, the lignosulfonate is modified sodium lignosulphonate. In some embodiments, the modified sodium lignosulphonate is Ufoxane 3A.

In some embodiments, the dispersing agent is a modified styrene acrylic polymer. In some embodiments, the hydrophobically modified polyacrylate is a modified styrene acrylic polymer. In some embodiments, the modified styrene acrylic polymer is Atlox Metasperse 550S.

In some embodiments, the dispersing agent is a combination of modified sodium lignosulphonate and modified styrene acrylic polymer. In some embodiments, the dispersing agent is a combination of Ufoxane 3A and Atlox Metasperse 550S.

In some embodiments, the dispersing agent is a block copolymer comprising 77% of sodium 2-acryloylamino-2-methylpropane-1-sulfonate (AMPS) monomers and 23% of the ethyl acrylate (EA) monomers.

In some embodiments, the dispersing agent is a water solution of 30% w/w solution of a block copolymer comprising 77% of sodium 2-acryloylamino-2-methylpropane-1-sulfonate (AMPS) monomers and 23% of ethyl acrylate (EA) monomers, which may be prepared as described in Example 1 of WO2017/098325. The water content of the solution is dried out of the solid composition as described herein below.

In some embodiments, the amount of dispersing agent(s) in the water dispersible solid composition is between about 1% to about 15% w/w based on the total weight of the composition. In some embodiments, the amount of dispersing agent(s) in the water dispersible solid composition is between about 2% to about 10% w/w based on the total weight of the composition. In some embodiments, the amount of dispersing agent(s) in the water dispersible solid composition is about 9% w/w based on the total weight of the composition.

A liquid oily and/or organic additive may be added to the water dispersible solid composition comprising novaluron. An amount of the novaluron may become dissolved in the liquid oily and/or organic additive. In some embodiments, the water dispersible solid composition comprises a liquid oily and/or organic additive in an amount that allows for up to 1% w/w of the total novaluron in the water dispersible solid composition to be dissolved after mixing with water.

In some embodiments, the water dispersible solid composition is substantially free of liquid oily additive. In some embodiments, the solid dispersible solid composition is substantially free of liquid organic additive.

As used herein, the term “substantially free” when used in connection with a component in a combination, mixture or composition means that the amount of the component in the combination, mixture or composition is 0.1% w/w or less based on the total weight of the combination, mixture or composition.

In some embodiments, the amount of the liquid oily additive in the water dispersible solid composition is 0.1% w/w or less based on the total weight of the composition. In some embodiments, the amount of the liquid oily additive in the water dispersible solid composition is 0.05% w/w or less based on the total weight of the composition. In some embodiments, the amount of the liquid oily additive in the water dispersible solid composition is 0.01% w/w or less based on the total weight of the composition. In some embodiments, the water dispersible solid composition is free of liquid oily additive.

In some embodiments, the amount of the liquid organic additive in the water dispersible solid composition is 0.1% w/w or less based on the total weight of the composition. In some embodiments, the amount of the liquid organic additive in the water dispersible solid composition is 0.05% w/w or less based on the total weight of the composition. In some embodiments, the amount of the liquid organic additive in the water dispersible solid composition is 0.01% w/w or less based on the total weight of the composition. In some embodiments, the solid dispersible solid composition is free of liquid organic additive.

In some embodiments, the agriculturally acceptable additive is an agriculturally acceptable solid additive. In some embodiments, the water dispersible solid composition, with or without the organo-silicone based surfactant, comprises an agricultural acceptable solid additive. In some embodiments, the water dispersible solid composition comprises at least two agriculturally acceptable solid additives.

In some embodiments, the agricultural acceptable solid additive is filler and/or binder.

In some embodiments, the agricultural acceptable solid additive is dispersible in water.

In some embodiments, the agricultural acceptable solid additive is soluble in water.

In some embodiments, the agriculturally acceptable solid additive is a solid filler.

In some embodiments, the agriculturally acceptable solid additive is binder.

In some embodiments, the agriculturally acceptable solid additive can function as filler and/or binder.

In some embodiments, the agriculturally acceptable solid additive is selected from the group consisting of silica, clay, corn starch, talc, lactose monohydrate, ammonium sulfate (binder and filler), sucrose, magnesium stearate, glucose, cellulose, calcium carbonate, and any combination thereof. In some embodiments, the filler and/or binder is selected from the group consisting of silica, clay, corn starch, talc, lactose monohydrate, ammonium sulfate (binder and filler), sucrose, magnesium stearate, glucose, cellulose, calcium carbonate, and any combination thereof.

In some embodiments, the agriculturally acceptable solid additive is a combination of corn starch and talc.

In some embodiments, the amount of the agriculturally acceptable solid additive(s) in the water dispersible solid composition is between about 2% to about 50% w/w based on the total weight of the water dispersible solid composition. In some embodiments, the amount of the agriculturally acceptable solid additive(s) in the water dispersible solid composition is between about 1% to about 15% w/w based on the total weight of the water dispersible solid composition. In some embodiments, the amount of the agriculturally acceptable solid additive (s) in the solid composition is between about 6-8% w/w based on the total weight of the water dispersible solid composition. In some embodiments the amount of the agriculturally acceptable solid additive(s) in the water dispersible solid composition is about 8% w/w based on the total weight of the water dispersible solid composition. In some embodiments, the amount of the agriculturally acceptable solid additive(s) in the water dispersible solid composition is about 6.5% w/w based on the total weight of the water dispersible solid composition.

In some embodiments, the water dispersible solid composition comprises corn starch.

In some embodiments, the amount of corn starch in the water dispersible solid composition is between about 0.5% to about 5% w/w based on the total weight of the water dispersible solid composition. In some embodiments, the amount of corn starch in the water dispersible solid composition is about 1% w/w based on the total weight of the water dispersible solid composition.

In some embodiments, the water dispersible solid composition comprises talc.

In some embodiments, the amount of talc in the water dispersible solid composition is between about 1% to about 15% w/w based on the total weight of the water dispersible solid composition. In some embodiments, the amount of talc in the water dispersible solid composition is about 5.5% w/w based on the total weight of the water dispersible solid composition.

In some embodiments, the particle size of the agriculturally acceptable solid additive is less than 30 microns (D90). In some embodiments, the particle size of the agriculturally acceptable solid additive is less than 25 microns (D90). In some embodiments, the particle size of the agriculturally acceptable solid additive is less than 20 micron (D90). In some embodiments, the particle size of the filler and/or binder is less than 20 micron (D90).

In some embodiments, the agriculturally acceptable additive is a functional additive. In some embodiments, the water dispersible solid composition comprises at least one functional additive.

In some embodiments, the functional additive is solid. In some embodiments, the functional additive is liquid.

In some embodiments, the functional additive is selected from the group consisting of anti-foaming agent, biocides, water absorbents, water scavengers, adjuvants and any combination thereof.

When the water dispersible solid composition is mixed with water, components of the water dispersible solid composition may dissolve in the water and/or disperse in the form of solid particles in the water.

For the components that disperse in water in the form of solid particles, the water dispersible solid composition is formulated to disperse these component(s) in the form of solid particles having small particle sizes. Components of the water dispersible solid composition include novaluron, organo-silicone based surfactant, and agriculturally acceptable additive(s), but not all of these components will disperse in water.

In some embodiments, the water dispersible solid composition is formulated to disperse all components of the water dispersible solid composition that form solid particles in water in solid particles having a particle size distribution D90 of 30 microns or less. In some embodiments, the water dispersible solid composition is formulated to disperse all components of the water dispersible solid composition that form solid particles in water in solid particles having a particle size distribution D90 of 25 microns or less. In some embodiments, the water dispersible solid composition is formulated to disperse all components of the water dispersible solid composition that form solid particles in water in solid particles having a particle size distribution D90 of 20 microns or less. In some embodiments, the water dispersible solid composition is formulated to disperse all components of the water dispersible solid composition that form solid particles in water in solid particles having a particle size distribution D95 of 35 microns or less. In some embodiments, the water dispersible solid composition is formulated to disperse all components of the water dispersible solid composition that form solid particles in water in solid particles having a particle size distribution D95 of 20 microns or less. In some embodiments, the water dispersible solid composition is formulated to disperse all components of the water dispersible solid composition that form solid particles in water in solid particles having a particle size distribution D99 of 40 microns or less. In some embodiments, the water dispersible solid composition is formulated to disperse all components of the water dispersible solid composition that form solid particles in water in solid particles having a particle size distribution D99 of 20 microns or less. In some embodiments, the water dispersible solid composition is formulated to disperse all components of the water dispersible solid composition that form solid particles in water in solid particles having a particle size of 45 microns or less. In some embodiments, the water dispersible solid composition is formulated to disperse all components of the water dispersible solid composition that form solid particles in water in solid particles having a particle size of 20 microns or less.

In some embodiments, the water dispersible solid composition is formulated to disperse all components of the water dispersible solid composition that form solid particles in water in solid particles having particle sizes between 5 to 20 microns. In some embodiments, the water dispersible solid composition is formulated to disperse all components of the water dispersible solid composition that form solid particles in water in solid particles having particle sizes between 6 to 20 microns. In some embodiments, the water dispersible solid composition is formulated to disperse all components of the water dispersible solid composition that form solid particles in water in solid particles having particle sizes between 7 to 20 microns. In some embodiments, the water dispersible solid composition is formulated to disperse all components of the water dispersible solid composition that form solid particles in water in solid particles having particle sizes between 10 to 20 microns.

In some embodiments, the water dispersible solid composition is formulated to disperse all components of the water dispersible solid composition that form solid particles in water in solid particles having a particle size distribution D90 between 5 to 20 microns. In some embodiments, the water dispersible solid composition is formulated to disperse all components of the water dispersible solid composition that form solid particles in water in solid particles having a particle size distribution D90 between 6 to 20 microns. In some embodiments, the water dispersible solid composition is formulated to disperse all components of the water dispersible solid composition that form solid particles in water in solid particles having a particle size distribution D90 between 7 to 20 microns. In some embodiments, the water dispersible solid composition is formulated to disperse all components of the water dispersible solid composition that form solid particles in water in solid particles having a particle size distribution D90 between 10 to 20 microns.

In some embodiments, the water dispersible solid composition is formulated to disperse all components of the water dispersible solid composition that form solid particles in water in solid particles having a particle size distribution D95 between 5 to 35 microns. In some embodiments, the water dispersible solid composition is formulated to disperse all components of the water dispersible solid composition that form solid particles in water in solid particles having a particle size distribution D95 between 5 to 20 microns. In some embodiments, the water dispersible solid composition is formulated to disperse all components of the water dispersible solid composition that form solid particles in water in solid particles having a particle size distribution D95 between 6 to 35 microns. In some embodiments, the water dispersible solid composition is formulated to disperse all components of the water dispersible solid composition that form solid particles in water in solid particles having a particle size distribution D95 between 6 to 20 microns. In some embodiments, the water dispersible solid composition is formulated to disperse all components of the water dispersible solid composition that form solid particles in water in solid particles having a particle size distribution D95 between 7 to 35 microns. In some embodiments, the water dispersible solid composition is formulated to disperse all components of the water dispersible solid composition that form solid particles in water in solid particles having a particle size distribution D95 between 7 to 20 microns. In some embodiments, the water dispersible solid composition is formulated to disperse all components of the water dispersible solid composition that form solid particles in water in solid particles having a particle size distribution D95 between 10 to 20 microns.

In some embodiments, the water dispersible solid composition is formulated to disperse all components of the water dispersible solid composition that form solid particles in water in solid particles having a particle size distribution D99 between 5 to 40 microns.

In some embodiments, the water dispersible solid composition is formulated to disperse all components of the water dispersible solid composition that form solid particles in water in solid particles having a particle size distribution D99 between 5 to 20 microns. In some embodiments, the water dispersible solid composition is formulated to disperse all components of the water dispersible solid composition that form solid particles in water in solid particles having a particle size distribution D99 between 6 to 40 microns. In some embodiments, the water dispersible solid composition is formulated to disperse all components of the water dispersible solid composition that form solid particles in water in solid particles having a particle size distribution D99 between 6 to 20 microns. In some embodiments, the water dispersible solid composition is formulated to disperse all components of the water dispersible solid composition that form solid particles in water in solid particles having a particle size distribution D99 between 7 to 40 microns. In some embodiments, the water dispersible solid composition is formulated to disperse all components of the water dispersible solid composition that form solid particles in water in solid particles having a particle size distribution D99 between 7 to 20 microns. In some embodiments, the water dispersible solid composition is formulated to disperse all components of the water dispersible solid composition that form solid particles in water in solid particles having a particle size distribution D99 between 10 to 20 microns.

In some embodiments, the water dispersible solid composition is formulated to disperse all components of the water dispersible solid composition that form solid particles in water in solid particles having a particle size between 5 to 45 microns. In some embodiments, the water dispersible solid composition is formulated to disperse all components of the water dispersible solid composition that form solid particles in water in solid particles having a particle size between 5 to 20 microns. In some embodiments, the water dispersible solid composition is formulated to disperse all components of the water dispersible solid composition that form solid particles in water in solid particles having a particle size between 6 to 45 microns. In some embodiments, the water dispersible solid composition is formulated to disperse all components of the water dispersible solid composition that form solid particles in water in solid particles having a particle size between 6 to 20 microns. In some embodiments, the water dispersible solid composition is formulated to disperse all components of the water dispersible solid composition that form solid particles in water in solid particles having a particle size between 7 to 45 microns. In some embodiments, the water dispersible solid composition is formulated to disperse all components of the water dispersible solid composition that form solid particles in water in solid particles having a particle size between 7 to 20 microns. In some embodiments, the water dispersible solid composition is formulated to disperse all components of the water dispersible solid composition that form solid particles in water in solid particles having a particle size between 10 to 20 microns.

In some embodiments, the amount of novaluron in the composition is about 60-80% w/w based on the total weight of the composition. In some embodiments, the amount of novaluron in the composition is about 80% w/w based on the total weight of the composition.

In some embodiments, the amount of the organo-silicone based surfactant in the composition is 0.5-2.5% w/w based on the total weight of the composition. In some embodiments, the amount of the organo-silicone based surfactant in the composition is 1.5% w/w based on the total weight of the composition. In some embodiments, the amount of Silwet® L-77 in the composition is 0.5-2.5% w/w based on the total weight of the composition. In some embodiments, the amount of Silwet® L-77 in the composition is 1.5% w/w based on the total weight of the composition.

In some embodiments, wherein when the composition is mixed with water, the novaluron is dispersed in water in the form of solid particles.

In some embodiments, the present invention provides a water dispersible solid composition comprising:
(1) novaluron in amount of about 60-80% w/w based on the total weight of the composition, and
(2) an organo-silicone based surfactant in amount of about 0.5-2.5% w/w based on the total weight of the composition.

In some embodiments, the present invention provides a water dispersible solid composition comprising:
(1) novaluron in amount of about 80% w/w based on the total weight of the composition, and
(2) an organo-silicone based surfactant in amount of about 1.5% w/w based on the total weight of the composition.

In some embodiments, the present invention provides a water dispersible solid composition comprising:
(1) novaluron in amount of about 60-80% w/w based on the total weight of the composition, and
(2) an organo-silicone based surfactant in amount of about 0.5-2.5% w/w based on the total weight of the composition,
wherein when the composition is mixed with water, the novaluron is dispersed in water in the form of solid particles.

In some embodiments, the present invention provides a water dispersible solid composition comprising:
(1) novaluron in amount of about 80% w/w based on the total weight of the composition, and
(2) an organo-silicone based surfactant in amount of about 1.5% w/w based on the total weight of the composition,
wherein when the composition is mixed with water, the novaluron is dispersed in water in the form of solid particles.

In some embodiments, the present invention provides a water dispersible solid composition comprising:
(1) novaluron in amount of about 60-80% w/w based on the total weight of the composition, and
(2) Silwet® L-77 in amount of about 0.5-2.5% w/w based on the total weight of the composition.

In some embodiments, the present invention provides a water dispersible solid composition comprising:
(1) novaluron in amount of about 80% w/w based on the total weight of the composition, and
(2) Silwet® L-77 in amount of about 1.5% w/w based on the total weight of the composition.

In some embodiments, the present invention provides a water dispersible solid composition comprising:
(1) novaluron in amount of about 60-80% w/w based on the total weight of the composition, and
(2) Silwet® L-77 in amount of about 0.5-2.5% w/w based on the total weight of the composition,
wherein when the composition is mixed with water, the novaluron is dispersed in water in the form of solid particles.

In some embodiments, the present invention provides a water dispersible solid composition comprising:
(1) novaluron in amount of about 80% w/w based on the total weight of the composition, and
(2) Silwet® L-77 in amount of about 1.5% w/w based on the total weight of the composition,
wherein when the composition is mixed with water, the novaluron is dispersed in water in the form of solid particles.

In some embodiments, the present invention provides a water dispersible solid composition comprising:
(1) novaluron in amount of about 80% w/w based on the total weight of the composition,
(2) organo-silicone based surfactant in amount of about 1.5% w/w based on the total weight of the composition,
(3) dispersing agent(s) in amount of about 9% w/w based on the total weight of the composition,
(4) wetting agent in amount of about 3% w/w based on the total weight of the composition, and
(5) agriculturally acceptable solid additive in amount of about 6.5% w/w based on the total weight of the composition.

In some embodiments, the present invention provides a water dispersible solid composition comprising:
(1) novaluron in amount of about 80% w/w based on the total weight of the composition,
(2) Silwet® L-77 in amount of about 1.5% w/w based on the total weight of the composition,
(3) dispersing agent(s) in amount of about 9% w/w based on the total weight of the composition,
(4) wetting agent in amount of about 3% w/w based on the total weight of the composition, and
(5) agriculturally acceptable solid additive in amount of about 6.5% w/w based on the total weight of the composition.

In some embodiments, the present invention provides a water dispersible solid composition comprising:
(1) novaluron in amount of about 80% w/w based on the total weight of the composition,
(2) Silwet® L-77 in amount of about 1.5% w/w based on the total weight of the composition,
(3) Morwet® EFW in amount of about 3% w/w based on the total weight of the composition,
(4) Ufoxane® 3A in amount of about 2% w/w based on the total weight of the composition,
(5) Atlox Metasperse® 550S in amount of 7% w/w based on the total weight of the composition,
(6) corn starch in amount of about 1% w/w based on the total weight of the composition, and
(7) talc in amount of about 5.5% w/w based on the total weight of the composition.

In some embodiments, the water dispersible solid composition is prepared using novaluron in solid form.

In some embodiments, the water dispersible solid composition forms an aqueous suspension on dilution with water, comprising novaluron in the form of solid particles with a particle size distribution characterized by a D90 of between 4 to 30 micron, a D95 of 35 microns or less, and a D99 of 40 microns or less, wherein the water dispersible solid composition maintains a suspensibility of greater than 80%, preferably greater than 85% and lower than 105% suspended solids after storage at 54° C. for 14 days when tested according to CIPAC Test MT 184.

In some embodiments, the water dispersible solid composition forms an aqueous suspension on dilution with water, comprising novaluron in the form of solid particles with a particle size distribution characterized by a D90 of between 10 to 30 microns, wherein the water dispersible solid composition maintains a suspensibility of greater than 80%, preferably greater than 85% and lower than 105% suspended solids after storage at 54° C. for 14 days when tested according to CIPAC Test MT 184.

In some embodiments, the water dispersible solid composition forms an aqueous suspension on dilution with water, comprising novaluron in the form of solid particles with a particle size distribution characterized by a D90 of between 10 to 20 micron, wherein the water dispersible solid composition maintains a suspensibility of greater than 80%, preferably greater than 85% and lower than 105% suspended solids after storage at 54° C. for 14 days when tested according to CIPAC Test MT 184.

### Suspension

When the water dispersible solid composition of the present invention, which comprises novaluron and may or may not comprises organo-silicone based surfactant, is mixed with water, the novaluron is dispersed as solid particles in the water to form a suspension.

In some embodiments, the suspension is an aqueous suspension.

The present invention provides a suspension comprising any one of the combinations and/or compositions described herein and water.

The present invention provides a suspension prepared from the combination and/or composition described herein.

The present invention provides a suspension comprising any one of the water dispersible solid compositions described herein and water. The present invention provides a suspension prepared by using any water dispersible solid composition described herein.

The present invention provides a suspension comprising solid particulate of novaluron and wherein the suspension is prepared from a water dispersible solid composition of novaluron.

The present invention provides a suspension comprising novaluron in form of solid particles and organo-silicone based surfactant, wherein the suspension composition is prepared from a water dispersible solid composition of novaluron.

The present invention provides a suspension comprising novaluron in the form of solid particles for controlling insects in the vicinity of pesticide sensitive crop.

The present invention provides a suspension composition comprising novaluron in form of solid particles and wherein the suspension composition is prepared from a water dispersible solid composition comprising novaluron.

The present invention provides a suspension comprising novaluron in form of solid particles, wherein the suspension composition is prepared from combination of water dispersible solid composition comprising novaluron and organo-silicone based surfactant.

In some embodiments the organo-silicone based surfactant is part of the water dispersible solid composition (ready-mix composition).

In some embodiments, the organo-silicone based surfactant is used as tank mix with the water dispersible solid composition comprising novaluron.

In some embodiments, the organo-silicone based surfactant is used as part of the water dispersible solid composition and as tank mix with the water dispersible solid composition of novaluron.

In some embodiments, the organo-silicone based surfactant is formulated within the granules of novaluron as a ready-mix water dispersible solid composition.

In some embodiments, the combination of organo-silicone based surfactant and novaluron can be in the form of a ready-mix water dispersible solid composition and as tank mix.

In some embodiments the organo-silicone based surfactant is added as tank mix.

In some embodiments, the suspension is physically stable.

In some embodiments, physical stability of the suspension refers to a state when the novaluron particles are dispersed and do not float on the water surface.

In some embodiments, the invention provides a physically stable water dispersible solid composition that forms an aqueous suspension on dilution with water, comprising novaluron in the form of solid particles with a particle size distribution characterized by a D90 of between 4 to 30 micron, a D95 of 35 microns or less, and a D99 of 40 microns or less, wherein the water dispersible solid composition maintains a suspensibility of greater than 80%, preferably greater than 85% and lower than 105% suspended solids after storage at 54° C. for 14 days when tested according to CIPAC Test MT 184.

In some embodiments, the invention provides a physically stable water dispersible solid composition that forms an aqueous suspension on dilution with water, comprising novaluron in the form of solid particles with a particle size distribution characterized by a D90 of between 10 to 30 microns, wherein the water dispersible solid composition maintains a suspensibility of greater than 80%, preferably greater than 85% and lower than 105% suspended solids after storage at 54° C. for 14 days when tested according to CIPAC Test MT 184.

In some embodiments, the invention provides a physically stable water dispersible solid composition that forms an aqueous suspension on dilution with water, comprising novaluron in the form of solid particles with a particle size distribution characterized by a D90 of between 10 to 20 micron, wherein the water dispersible solid composition maintains a suspensibility of greater than 80%, preferably greater than 85% and lower than 105% suspended solids after storage at 54° C. for 14 days when tested according to CIPAC Test MT 184.

In some embodiments, the invention provides a physically stable water dispersible solid composition that forms an aqueous suspension on dilution with water, comprising novaluron in the form of solid particles with a particle size distribution characterized by a D90 of between 4 to 30 micron and a Dos of 35 microns or less and a D99 of 40 microns or less, and an organo-silicone based surfactant, wherein the water dispersible solid composition maintains a suspensibility of greater than 80%, preferably greater than 85% and lower than 105% suspended solids after storage at 54° C. for 14 days when tested according to CIPAC Test MT 184.

In some embodiments, the invention provides a physically stable water dispersible solid composition that forms an aqueous suspension on dilution with water, comprising novaluron in the form of solid particles with a particle size distribution characterized by a D90 value of between 10 to 30 micron and an organo-silicone based surfactant, wherein the water dispersible solid composition maintains a suspensibility of greater than 80%, preferably greater than 85% and lower than 105% suspended solids after storage at 54° C. for 14 days when tested according to CIPAC Test MT 184.

In some embodiments, the invention provides a physically stable water dispersible solid composition that forms an aqueous suspension on dilution with water, comprising novaluron in the form of solid particles with a particle size distribution characterized by a D90 of between 10 to 20 micron and an organo-silicone based surfactant, wherein the water dispersible solid composition maintains a suspensibility of greater than 80%, preferably greater than 85% and lower than 105% suspended solids after storage at 54° C. for 14 days of water dispersible solid composition when tested according to CIPAC Test MT 184.

In some embodiments, the invention provides a water dispersible solid composition that forms an aqueous suspension on dilution with water, comprising novaluron in the form of solid particles with a particle size distribution characterized by a D90 of between 4 to 30 micron and a Dos of 35 microns or less and D99 of 40 microns or less, wherein the water dispersible solid composition maintains a suspensibility of greater than 75%, preferably greater than 80%, more preferably greater than 85% and lower than 105% suspended solids after storage at 54° C. for 14 days when tested according to CIPAC Test MT 184.

In some embodiments, the invention provides a water dispersible solid composition that forms an aqueous suspension on dilution with water, comprising novaluron in the form of solid particles with a particle size distribution characterized by a D90 of between 10 to 30 microns, wherein the water dispersible solid composition maintains a suspensibility of greater than 75%, preferably greater than 80%, more preferably greater than 85% and lower than 105% suspended solids after storage at 54° C. for 14 days when tested according to CIPAC Test MT 184.

In some embodiments, the invention provides a water dispersible solid composition that forms an aqueous suspension on dilution with water, comprising novaluron in the form of solid particles with a particle size distribution characterized by a D90 of between 10 to 20 micron, wherein the water dispersible solid composition maintains a suspensibility of greater than 75%, preferably greater than 80%, more preferably greater than 85% and lower than 105% suspended solids after storage at 54° C. for 14 days when tested according to CIPAC Test MT 184.

In some embodiments, the invention provides a water dispersible solid composition that forms an aqueous suspension on dilution with water, comprising novaluron in the form of solid particles with a particle size distribution characterized by a D90 of between 4 to 30 micron and a D95 of 35 microns or less and a D99 of 40 microns or less, and an organo-silicone based surfactant, wherein the water dispersible solid composition maintains a suspensibility of greater than 75%, preferably greater than 80%, more preferably greater than 85% and lower than 105% suspended solids after storage at 54° C. for 14 days when tested according to CIPAC Test MT 184.

In some embodiments, the invention provides a water dispersible solid composition that forms an aqueous suspension on dilution with water, comprising novaluron in the form of solid particles with a particle size distribution characterized by a D90 value of between 10 to 30 micron and an organo-silicone based surfactant, wherein the water dispersible solid composition maintains a suspensibility of greater than 75%, preferably greater than 80%, more preferably greater than 85% and lower than 105% suspended solids after storage at 54° C. for 14 days when tested according to CIPAC Test MT 184.

In some embodiments, the invention provides a water dispersible solid composition that forms an aqueous suspension on dilution with water, comprising novaluron in the form of solid particles with a particle size distribution characterized by a D90 of between 10 to 20 micron and an organo-silicone based surfactant, wherein the water dispersible solid composition maintains a suspensibility of greater than 75%, preferably greater than 80%, more preferably greater than 85% and lower than 105% suspended solids after storage at 54° C. for 14 days when tested according to CIPAC Test MT 184.

### Suspension for Use

The present invention provides a suspension comprising novaluron in the form of solid particles for controlling insect in the vicinity of pesticide sensitive crop.

In some embodiments, the suspension is prepared using the composition described herein.

In some embodiments, the suspension is prepared from solid composition in water.

In some embodiments, the suspension is prepared from liquid composition.

In some embodiments, liquid composition is oil dispersion.

In some embodiments, the liquid composition is suspension concentrate.

### Uses

The present invention provides use of an organo-silicone based surfactant for dispersing novaluron in the form of solid particles in water.

In some embodiments, the organo-silicone based surfactant is used to prepare a suspension comprising novaluron in the form of solid particles in water.

In some embodiments, the organo-silicone based surfactant is used to prepare a water dispersible solid composition comprising novaluron.

The present invention provides the use of novaluron in form of solid particle for controlling unwanted insects or disease caused by unwanted insects.

The present invention provides the use of novaluron in form of solid particle for controlling unwanted insects or disease caused by unwanted insects in the vicinity of pesticide sensitive crop.

### Methods of Use

Many crops are sensitive to pesticidal application. Pesticide sensitive crops are crops such as cucumber, lettuce, pepper, cabbages, wine grapes and cucurbits that can be injured by the application of pesticides. The pesticide is penetrating to the crop and may cause damages to the crop growth and development. It was found that novaluron applied in the form of solid particles is safer to pesticide sensitive crop.

The present invention also provides a method for controlling unwanted insects comprising applying an effective amount of any one of the herein described combination, composition and/or suspension to a plant, a locus thereof, propagation material thereof, or an area infested with the unwanted insects so as to thereby control the unwanted insects.

The present invention also provides a method for controlling plant disease caused by unwanted insect comprising applying an effective amount of any one of the herein described combination, composition and/or suspension to a plant, a locus thereof, propagation material thereof, or an area infested with the unwanted insect so as to thereby control the plant disease caused by unwanted insect.

In some embodiments, the locus of the plant is the vicinity of the plant.

In some embodiments, the area infested with the unwanted insects is a plant.

In some embodiments, the plant is a pesticide sensitive crop.

In some embodiments, the pesticide sensitive crop is cucumber. In some embodiments, the pesticide sensitive crop is lettuce. In some embodiments, the pesticide sensitive crop is pepper. In some embodiments, the pesticide sensitive crop is cabbage. In some embodiments, the pesticide sensitive crop is cucurbit. In some embodiments, the pesticide sensitive crop is wine grapes.

In some embodiments, the suspension is obtained using one of the processes of preparation described herein.

The present invention also provides a method for controlling unwanted insects comprising (1) obtaining a suspension described herein and (2) contacting a plant, a locus thereof, propagation material thereof, or an area infested with the unwanted insects with an effective amount of the suspension so as to thereby control the unwanted insects.

The present invention also provides a method for controlling plant disease caused by unwanted insect, comprising (1) obtaining a suspension described herein and (2) contacting a plant, a locus thereof, propagation material thereof, or an area infested with the unwanted insects with an effective amount of the suspension so as to thereby control the plant disease.

In some embodiment, step (1) comprises (i) obtaining a water dispersible solid composition described herein, and (ii) mixing the water dispersible solid composition with water to obtain the suspension.

The present invention also provides a method for controlling unwanted insects comprising (1)(i) obtaining a water dispersible solid composition described herein, (1)(ii) mixing the water dispersible solid composition with water to obtain a suspension, and (2) contacting a plant, a locus thereof, propagation material thereof, or an area infested with the unwanted insects with an effective amount of the suspension so as to thereby control the unwanted insects.

The present invention also provides a method for controlling plant disease caused by unwanted insect comprising (1)(i) obtaining a water dispersible solid composition described herein, (1)(ii) mixing the water dispersible solid composition with water to obtain a suspension, and (2) contacting a plant, a locus thereof, propagation material thereof, and/or an area infested with the unwanted insect with an effective amount of the suspension so as to thereby control the plant disease caused by unwanted insect.

In some embodiments, the water dispersible solid composition obtained in step (1)(i) comprises an organo-silicone based surfactant.

In some embodiments, the water dispersible solid composition obtained in step (1)(i) is substantially free or free of organo-silicone based surfactant and step (1)(ii) comprises mixing an organo-silicone based surfactant with the water dispersible solid composition and water.

In some embodiments, the water dispersible solid composition obtained in step (1)(i) comprises an organo-silicone based surfactant and step (1)(ii) comprises mixing an organo-silicone based surfactant with the water dispersible solid composition and water.

In some embodiments, step (1)(ii) comprises mixing the organo-silicone based surfactant with water before the water dispersible solid composition is mixed with water.

In some embodiments, step (1)(ii) comprises mixing the water dispersible solid composition with water before the organo-silicone based surfactant is mixed with water.

In some embodiments, step (1)(ii) comprises mixing the water dispersible solid composition and the organo-silicone based surfactant with water simultaneously.

In some embodiments, the water dispersible solid composition is obtained using one of the processes of preparation described herein.

In some embodiments, the area infested with unwanted insects is a plant. In some embodiments, the area infested with unwanted insects is soil.

Controlling unwanted insects includes preventing infestation by unwanted insects and/or reducing the number of unwanted insects in the area.

In some embodiments, the method is effective for preventing infestation by unwanted insects. In some embodiments, the method is effective for reducing the number of unwanted insects.

The suspension applied for controlling unwanted insect infestation and/or plant disease may be applied as persistence treatment and/or knock down treatment. In some embodiments, the suspension is applied as a persistence treatment. In some embodiments, the suspension is applied as a knockdown treatment.

In some embodiments, the method is effective for preventing the plant disease caused by unwanted insects. In some embodiments, the method is effective for curing the plant disease caused by unwanted insects.

In some embodiments, the particle size of the novaluron solid particle in the suspension is less than 30 microns. In some embodiments, the particle size of the novaluron solid particle in the suspension is less than 20 microns.

In some embodiments, the particle size of the novaluron solid particle in the suspension is between 4-20 microns. In some embodiments, the particle size of the novaluron solid particle in the suspension is between 10-20 microns.

In some embodiments, the distribution D90 of novaluron solid particle in the suspension is between 4-20 micron. In some embodiments, the distribution D90 of novaluron solid particle in the suspension is between 10-20 micron.

In some embodiments, the combination or composition is applied at a rate from about 100 ppm to about 1000 ppm of novaluron. In some embodiments, the combination or composition is applied at a rate from about 100 ppm to about 500 ppm of novaluron. In some embodiments, the combination or composition is applied at a rate from about 200 ppm to about 400 ppm of novaluron. In some embodiments, the combination or composition is applied at a rate of about 200 ppm of novaluron. In some embodiments, the combination or composition is applied at a rate of about 200-500 ppm of novaluron.

In some embodiments, the suspension is applied at a rate from about 40 gr/ha to about 180 g/ha of novaluron.

In some embodiments, the suspension is applied at a rate from about 50 gr/ha to about 150 g/ha of novaluron.

In some embodiments, the pesticide sensitive crop is cucumber. In some embodiments, the pesticide sensitive crop is lettuce. In some embodiments, the pesticide sensitive crop is pepper. In some embodiments, the pesticide sensitive crop is cabbage. In some embodiments, the pesticide sensitive crop is cucurbit. In some embodiments, the pesticide sensitive crop is wine grapes

In some embodiments, when the pesticide sensitive crop is cucumber, the suspension is applied at a rate from about 40 gr/ha to about 180 g/ha of novaluron. In some embodiments, when the pesticide sensitive crop is cucumber, the suspension is applied at a rate from about 40 gr/ha to about 150 g/ha of novaluron. In some embodiments, when the pesticide sensitive crop is cucumber, the suspension is applied at a rate from about 50 gr/ha to about 115 g/ha of novaluron.

In some embodiments, when the pesticide sensitive crop is lettuce, the suspension is applied at a rate from about 50 gr/ha to about 180 g/ha of novaluron. In some embodiments, when the pesticide sensitive crop is lettuce, the suspension is applied at a rate from about 50 gr/ha to about 150 g/ha of novaluron. In some embodiments, when the pesticide sensitive crop is lettuce, the suspension is applied at a rate from about 65 gr/ha to about 115 g/ha of novaluron.

In some embodiments, when the pesticide sensitive crop is pepper, the suspension is applied at a rate from about 40 gr/ha to about 180 g/ha of novaluron In some embodiments, when the pesticide sensitive crop is pepper, the suspension is applied at a rate from about 40 gr/ha to about 150 g/ha of novaluron. In some embodiments, when the pesticide sensitive crop is pepper, the suspension is applied at a rate from about 50 gr/ha to about 115 g/ha of novaluron.

In some embodiments, when the pesticide sensitive crop is cabbage, the suspension is applied at a rate from about 50 gr/ha to about 200 g/ha of novaluron. In some embodiments, when the pesticide sensitive crop is cabbage, the suspension is applied at a rate from about 65 gr/ha to about 115 g/ha of novaluron.

In some embodiments, when the pesticide sensitive crop is cucurbit, the suspension is applied at a rate from about 40 gr/ha to about 150 g/ha of novaluron. In some embodiments, when the pesticide sensitive crop is cucurbit, the suspension is applied at a rate from about 50 gr/ha to about 115 g/ha of novaluron.

In some embodiments, when the pesticide sensitive crop is wine grapes, the suspension is applied at a rate from about 40 gr/ha to about 130 g/ha of novaluron. In some embodiments, when the pesticide sensitive crop is wine grapes, the suspension is applied at a rate from about 50 gr/ha to about 100 g/ha of novaluron.

In some embodiments, the suspension is applied once during a growing season.

In some embodiments, the suspension is applied at least one time during a growing season.

In some embodiments, the suspension is applied two or more times during a growing season.

In some embodiments, the combination or composition is applied to soil. In some embodiments, the combination or composition is applied to foliage.

In some embodiments, the suspension is applied at a rate from about 100 ppm to about 1000 ppm of novaluron. In some embodiments, the suspension is applied at a rate from about 100 ppm to about 500 ppm of novaluron. In some embodiments, the suspension is applied at a rate from about 200 ppm to about 400 ppm of novaluron. In some embodiments, the suspension is applied at a rate of about 200 ppm of novaluron. In some embodiments, the suspension is applied at a rate of about 200-500 ppm of novaluron.

In some embodiments, the suspension is applied to soil. In some embodiments, the suspension is applied to foliage.

In some embodiments, the method comprises mixing the water dispersible solid composition with water to obtain a suspension in a water tank prior to application.

The combinations, compositions, suspensions and methods described herein are particularly effective for controlling insects of, inter alia, the orders Lepidoptera, Coleoptera, Homoptera, Heteroptera, Diptera, Thysanoptera, Orthoptera, Anoplura, Siphonaptera, Mallophaga, Thysanura, Isoptera, Psocoptera and Hymenoptera, as well as representatives of the order Acarina of the families Ixodidae Argasidae, Tetranychidae and Dermanyssidae leaf rollers.

The combinations, compositions, suspensions and methods described herein are also effective in controlling flies, e.g. Musca domestica, termites, cockroaches and mosquito larvae.

The combinations, compositions, suspensions and methods described herein are also suitable for controlling plant-destructive feeding insects in ornamentals and crops of useful plants, especially in cotton (e.g. against Spodoptera littoralis and Heliothis virescens) and in fruit and vegetables (e.g. against Laspeyresia pomonella, Cydia pomonella, Lithocolletis blancardella, Stigmella malella, 4doxophyes orana, Psylla piri, Cryptophlebia leucotreta, Phyllocnistis citrella, Cydia molesta, Anarsia lineatella, Leptinotarsa decemlineata and Epilachna varivestis), as well as for controlling several species of mites, e.g., oleivora.

The combinations, compositions and suspensions disclosed herein may be applied to control and/or prevent a variety of insect in the presence of plant.

In some embodiments, the plant is a crop. In some embodiments, plant is a pesticide sensitive crop. In some embodiments, the crop is a soft crop such as vegetable and fruits.

The methods of the present invention may be used on any crop plants, including but not limited to monocotyledons such as sugar cane cereals, rice, maize (corn), and/or; or dicotyledon crop such as beets (such as sugar beet or fodder beet); fruits (such as pomes, stone fruits, or soft fruits, for example apples, pears, plums, peaches, almonds, cherries, strawberries, raspberries, or blackberries); leguminous plants (such as beans, lentils, peas, or soybeans); oil plants (such as rape, mustard, poppy, olives, sunflowers, coconut, castor oil plants, cocoa beans, or groundnuts); cucumber plants (such as marrows, cucumbers or melons); fiber plants (such as cotton, flax, hemp, or jute); citrus fruits (such as Winegrapes, oranges, lemons, grapefruit, or mandarins); vegetables (such as spinach, lettuce, cabbages, carrots, tomatoes, potatoes, cucurbits, or paprika); lauraceae (such as avocados, cinnamon, or camphor); tobacco; nuts; coffee; tea; vines; hops; durian; bananas; natural rubber plants; and ornamentals (such as flowers, shrubs, broad-leaved trees, or evergreens, for example conifers).

In some embodiments, the plants are monocotyledonous plants, more preferably, cereals. In a specific embodiment, the cereal crop is wheat. In another specific embodiment, the cereal crop is triticale. In another specific embodiment, the cereal crop is rye. In another specific embodiment, the cereal crop is oat. In a further embodiment, the cereal crop is barley. In another embodiment, the crop plants are rice plants. In still another embodiment, the crop plants are sugar cane plants. In yet another embodiment, the crop plants are corn plants.

The combinations, compositions, suspensions and methods described herein are further effective for controlling ectoparasites such as Lucilia sericata, in domestic animals and productive livestock, e.g. by treating animals' skin, cowsheds, barns, stables etc., and pastures.

According to a particular embodiment of the present method, the pesticidal composition is used to prepare a tank mix which is then applied via spraying to the area or crop needing treatment. The active ingredient concentration in the tank mix is adjusted to the particular application, depending on agricultural or non-agricultural application, the crop and the pest. Although various methods of application may be employed as the skilled artisan may appreciate, spraying is the preferred method of application.

In some embodiments, the method comprises applying the combination, composition, or suspension in conjunction with other pest control agents, either in a mixture or by sequential application. Examples of suitable additional pesticides include organophosphorus compounds, nitrophenols and derivatives thereof, formamidines, ureas, carbamates, pyrethroids, and chlorinated hydrocarbons preparations.

The present invention provides a method for controlling insect on or around pesticide sensitive crop, comprising contacting a crop, a locus thereof or propagation material thereof with an effective amount of any combination, composition and/or suspension disclosed herein, so as to thereby control the insect.

The present invention provides a method for controlling insect on or around pesticide sensitive crop, comprising contacting a crop, a locus thereof or propagation material thereof with an effective amount of suspension comprising novaluron, wherein the novaluron in form of solid articles, so as to thereby control the insect.

In some embodiments, the suspension is obtained using one of the processes of preparation described herein.

In some embodiments, the suspension is prepared from a solid composition. In some embodiments, the suspension is prepared by mixing a solid composition with water.

In some embodiments, the suspension is prepared from a liquid composition.

In some embodiments, liquid composition is an oil dispersion.

In some embodiments, the liquid composition is a suspension concentrate.

The present invention provides a water dispersible solid composition for controlling insect in the vicinity of pesticide sensitive crop, comprising novaluron in the form of solid particles.

The present invention provides a water dispersible solid composition for controlling insect in the vicinity of pesticide sensitive crop, comprising an amount of novaluron and an amount of organo-silicone based surfactant, wherein the novaluron is dispersed in water in the form of solid particles when the composition is mixed with water.

The present invention provides a water dispersible solid composition comprising novaluron for controlling unwanted insects.

The present invention provides a water dispersible solid composition comprising novaluron for controlling plant disease caused by unwanted insect.

The present invention provides a suspension composition comprising novaluron in the form of solid particles for controlling unwanted insects in the vicinity of pesticide sensitive crop.

The present invention provides a suspension composition for controlling insect in the vicinity of pesticide sensitive crop, comprising novaluron in the form of solid particles

### Preparation of Water Dispersible Solid Composition

The water dispersible solid composition of the present invention is prepared by wet granulation.

The present invention provides a process for preparing a water dispersible solid composition comprising novaluron, the process comprising (1) mixing novaluron in solid form with at least one agriculturally acceptable additive in solid form to prepare a pre-mix, (2) milling the premix of step (1) to prepare a milled blend, (3) wetting the milled blend with a wetting liquid, (4) perform wet granulation and drying.

In some embodiments, the agriculturally acceptable additive is selected from the group consisting of dispersing agent, wetting agent, filler, binder, anti-foaming agent, biocides, water absorbents, water scavengers, adjuvants and any combination thereof. In some embodiments, the agriculturally acceptable additive is selected from the group consisting of dispersing agent, wetting agent, filler, binder, and any combination thereof. In some embodiments, the agriculturally acceptable additive is a dispersing agent. In some embodiments, the agriculturally acceptable additive is a wetting agent. In some embodiments, the agriculturally acceptable additive is a filler. In some embodiments, the agriculturally acceptable additive is a binder.

The agriculturally acceptable additive in solid form, i.e. agriculturally acceptable solid additive, is combined with the novaluron in solid form to prepare a premix and milled to the desired particle size distribution.

In some embodiments, the solid components of the premix are milled to a particle size distribution d90 of 30 microns or less. In some embodiments, the solid components of the premix are milled to a particle size distribution d90 of 25 microns or less. In some embodiments, the solid components of the premix are milled to a particle size distribution d90 of 20 microns or less. In some embodiments, the solid components of the premix are milled to a particle size distribution d95 of 35 microns or less. In some embodiments, the solid components of the premix are milled to a particle size distribution d99 of 40 microns or less.

In some embodiments, the solid components of the premix are milled to a particle size distribution d90 of between 5 to 30 microns. In some embodiments, the solid components of the premix are milled to a particle size distribution d90 of between 5 to 20 microns. In some embodiments, the solid components of the premix are milled to a particle size distribution d90 of between 6 to 20 microns. In some embodiments, the solid components of the premix are milled to a particle size distribution d90 of between 7 to 20 microns. In some embodiments, the solid components of the premix are milled to a particle size distribution d90 of between 10 to 20 microns.

In some embodiments, the solid components of the premix are milled to a particle size distribution d95 between 5 to 35 microns. In some embodiments, the solid components of the premix are milled to a particle size distribution d95 between 5 to 20 microns. In some embodiments, the solid components of the premix are milled to a particle size distribution d95 between 6 to 35 microns. In some embodiments, the solid components of the premix are milled to a particle size distribution d95 between 6 to 20 microns. In some embodiments, the solid components of the premix are milled to a particle size distribution d95 between 7 to 35 microns. In some embodiments, the solid components of the premix are milled to a particle size distribution d95 between 7 to 20 microns. In some embodiments, the solid components of the premix are milled to a particle size distribution d95 of between 10 to 20 microns.

In some embodiments, the solid components of the premix are milled to a particle size distribution d99 between 5 to 40 microns. In some embodiments, the solid components of the premix are milled to a particle size distribution d99 between 5 to 20 microns. In some embodiments, the solid components of the premix are milled to a particle size distribution d99 between 6 to 40 microns. In some embodiments, the solid components of the premix are milled to a particle size distribution d99 between 6 to 20 microns. In some embodiments, the solid components of the premix are milled to a particle size distribution d99 between 7 to 40 microns. In some embodiments, the solid components of the premix are milled to a particle size distribution d99 between 7 to 20 microns. In some embodiments, the solid components of the premix are milled to a particle size distribution d99 between 10 to 20 microns.

In some embodiments, the solid components of the premix are milled such that all particles have a particle size between 5 to 45 microns. In some embodiments, the solid components of the premix are milled such that all particles have a particle size between 5 to 20 microns. In some embodiments, the solid components of the premix are milled such that all particles have a particle size between 6 to 45 microns. In some embodiments, the solid components of the premix are milled such that all particles have a particle size between 6 to 20 microns. In some embodiments, the solid components of the premix are milled such that all particles have a particle size between 7 to 45 microns. In some embodiments, the solid components of the premix are milled such that all particles have a particle size between 7 to 20 microns. In some embodiments, the solid components of the premix are milled such that all particles have a particle size between 10 to 20 microns.

In some embodiments, the wetting liquid is a water-based wetting solution comprising organo-silicone based surfactant.

In some embodiments, the wetting liquid is a combination of (1) a water-based wetting solution comprising organo-silicone based surfactant, and (2) water. In some embodiments, the water-based solution comprising organo-silicone based surfactant is added first followed by additional amount of water. In some embodiments, the additional water is added after adding the water-based wetting solution comprising organo-silicone based surfactant.

In some embodiments, the process further comprises addition of water prior step (4).

The present invention provides a process for preparing water dispersible solid composition comprising novaluron, the process comprising (1) preparing a mixture of novaluron having particle size of 10 to 20 microns with a wetting agent, a dispersing agent and optionally a solid additive, (2) wet granulation of the mixture of step (1) using a water-based wetting liquid comprising organo-silicone based surfactant to obtain a wetted solid composition, and (4) drying the obtained wetted solid composition.

In some embodiments, the wetted solid composition is in the form of granules.

In some embodiments, water is used for wet granulation. In some embodiments, the amount of water used for wet granulation is between 7 to 20% w/w based on the total weight of the wetted solid composition before drying (during preparation). In some embodiments, the amount of water used for wet granulation is about 8.5% w/w based on the total weight of the wetted solid composition before drying (during preparation).

In some embodiments, part of the amount of water for wet granulation is added as a solution of water and organo-silicone based surfactant.

In some embodiments, the organo-silicone based surfactant is added during the wetting step of granulation.

In some embodiments, the wet granulation is performed by extrusion process.

In some embodiments, the wet granulation is pan granulation.

In some embodiment, the wetting liquid is sprayed onto the mixture of step (2) to obtain granules.

In some embodiments, the granules are dried using a fluidized bed.

In some embodiments, the granules are dried by lyophilization of the remaining solution.

In some embodiments, the granules are dried by spray-drying.

In some embodiments, the granules are dried by freeze-drying.

In some embodiments, the granules are dried by diafiltration.

In some embodiments, the granules are dried by dialysis.

In some embodiments, the granules are dried by vacuum drying.

In some embodiments, the granules are dried by heat drying.

### Preparation of Suspension

The present invention also provides a process for preparing a suspension comprising (i) solid particles of novaluron, (ii) organo-silicone based surfactant, and (iii) water, wherein the solid particles of novaluron are dispersed in water, comprising mixing (a) a water dispersible solid composition comprising novaluron and an organo-silicone based surfactant, and (b) water.

The present invention also provides a process for preparing a suspension comprising (i) solid particles of novaluron, (ii) organo-silicone based surfactant, and (iii) water, wherein the solid particles of novaluron are dispersed in water, comprising mixing (a) a water dispersible solid composition comprising novaluron, (b) an organo-silicone based surfactant, and (c) water.

The present invention also provides a process for preparing the suspension described herein, comprising mixing any one of the water dispersible solid compositions described herein with water.

The present invention provides a process for preparing a suspension comprising novaluron in the form of solid particles, the process comprising mixing the water dispersible solid composition disclosed herein with water.

In some embodiments, the water dispersible solid composition is a ready-mix water dispersible solid composition.

The present invention provides a process for preparing a suspension comprising novaluron in the form of solid particles, the process comprising mixing ready mix water dispersible solid composition with water.

The present invention provides a process for preparing a suspension comprising novaluron in the form of solid particles, the process comprising mixing an organo-silicone based surfactant, a water dispersible solid composition described herein and water. In some embodiments, the water dispersible solid composition is added into water. In some embodiments, water is added to the water dispersible solid composition. In some embodiments, the organo-silicone based surfactant is added to water prior to adding the water dispersible solid composition. In some embodiments, the water dispersible solid composition is added to water prior to adding the organo-silicone based surfactant.

In some embodiments, the water dispersible solid composition comprises an organo-silicone based surfactant. In some embodiments, the water dispersible solid composition is substantially free or free of organo-silicone based surfactant.

The present invention provides a suspension prepared using any water dispersible solid composition described herein. The present invention provides a suspension prepared using any water dispersible solid composition described herein and an effective amount of organo-silicone based surfactant.

In some embodiments, when the organo-silicone based surfactant is not formulated within the water dispersible solid composition, the organo-silicone based surfactant and the water dispersible solid compositions are added to water simultaneously.

In some embodiments, when the organo-silicone based surfactant is not formulated within the water dispersible solid composition, the organo-silicone based surfactant and the water dispersible solid composition are mixed prior to dilution with water.

### Package and Kit

The present invention provides a package comprising any one of the water dispersible solid compositions described herein, wherein the water dispersible solid composition comprises an organo-silicone based surfactant.

The present invention provides a package comprising any one of the water dispersible solid compositions described herein and an organo-silicone based surfactant, wherein the water dispersible solid composition is substantially free or free of organo-silicone based surfactant.

The present invention provides a package comprising any one of the water dispersible solid compositions described herein and an organo-silicone based surfactant, wherein the water dispersible solid composition comprises an organo-silicone based surfactant.

Each embodiment disclosed herein is contemplated as being applicable to each of the other disclosed embodiments. Thus, all combinations of the various elements described herein are within the scope of the invention. In addition, the elements recited in combination and/or composition embodiments can be used in the suspension, method, use, process and package embodiments described herein and vice versa.

In addition, when lists are provided, the list is to be considered as a disclosure of any one member of the list.

This invention will be better understood by reference to the Experimental Details which follow, but those skilled in the art will readily appreciate that the specific experiments detailed are only illustrative of the invention as described more fully in the claims which follow thereafter.

The invention is illustrated by the following examples without limiting it thereby.

### Experimental Section:

### Example 1—Two Water Dispersible Solid Compositions with 80% w/w of Novaluron and Organo-Silicone Based Surfactant Having D90 of 14 Microns (800 WDG 02) and D90 of 17 Microns (800 WDG 03)

The wetted solid composition comprising organo-silicone based surfactant and 80% w/w novaluron before drying is shown in Table 1.

TABLE 1
Composition before drying (wetted solid composition)

| | w/w % |
|---|---|
| Novaluron | 73.7 |
| Morwet EFW | 2.75 |
| Ufoxane 3A | 1.85 |
| Atlox Metasperse 550S | 6.45 |
| Corn starch | 0.92 |
| Talc | Balance |
| Silwet L-77 | 1.38 |
| water | 8.5 |

The wetted solid composition of Table 1 was dried to prepare the water dispersible solid composition comprising organo-silicone based surfactant 80% w/w of novaluron shown in Table 2.

TABLE 2
Water dispersible solid composition (after drying)

| | gr/Kg | w/w % |
|---|---|---|
| Novaluron | 800 | 80 |
| Morwet EFW | 30 | 3 |
| Ufoxane 3A | 20 | 2 |
| Atlox Metasperse 550S | 70 | 7 |
| Corn starch | 10 | 1 |
| Talc | Balance | 5.5 |
| Silwet L-77 | 15 | 1.5 |

Suppressibility at field rate >75%

The procedure for preparing novaluron 800 WDG (water dispersible solid composition in the form of granules) is summarized below.

Preparing premix: All solid ingredients (novaluron, Morwet EFW, Ufoxane 3A, Atlox Metasperse 550S, corn starch and talc) were mixed.

Milling: The premix was milled to the required particle size distribution of a d90 of 14 (800 WDG 02) or a d90 of 17 (800 WDG 03).

Post blending: the milled premix was blended.

Preparation of “wetting liquid”: Silwet L-77 in water (water amount is 7% w/w based on the weight of the wetted solid composition) was mixed for few minutes.

Dough preparation: the blended milled premix was wetted with all the “wetting liquid” and then additional water was added up 8.5% w/w based on the weight of the wetted solid composition for granulation.

Granulation: Dough was granulated by extrusion granulation using a screw extruder with dome opening of 1 mm diameter.

Drying: granules were dried in fluidized bed dryer for 20 min at 60° C.

### Example 2: Water Dispersible Solid Composition with 80% w/w Novaluron and No Organo-Silicone Based Surfactant (d90 is 17 Microns)

A water dispersible solid composition comprising 80% w/w novaluron and no organo-silicone based surfactant is shown in Table 3.

TABLE 3
Water dispersible solid composition (after drying)

| | gr/Kg | w/w % |
|---|---|---|
| Novaluron | 800 | 80 |
| Morwet EFW | 30 | 3 |
| Ufoxane 3A | 20 | 2 |
| Atlox metasperse 550S | 70 | 7 |
| Corn starch | 10 | 1 |
| Talc | Balance | 7 |

The water dispersible solid composition of Table 3 was prepared using the same procedure as described in Example 1, except Silwet L77 was not used to prepare the wetting liquid.

When the water dispersible solid composition of Table 3 was mixed with water, a suspension having a particle size distribution d90 of 17 microns was produced.

### Disintegrating Rate Measurement

In water dispersible solid composition, disintegration/wettability may be measured as “number of inversions”. The number of inversions is a qualitative measurement of 10 dispersibility, the lower the number of inversions the better the dispersibility.

A “wettable” water dispersible solid composition is when the number of inversions is lower than 20, more preferably, less than 15.

Disintegration was tested in the following manner:

2.5 gr of solid composition (800 WDG 03, d90 is 17; or 800 WDG 02, d90 is 14; or example 2) was added to 100 ml water in 250 ml cylinder.

The cylinder was then subjected to inversions (flips) repeated until all granules were disintegrated and the material was completely suspended.

Dispersibility test is performed (CIPAC MT 174) by adding 9 gr granules to 900 gr water, agitating at 300 RPM for 1 min and letting the mixture stand for 1 min, followed by removing (by vacuum suction) 810 ml from the top of the flask. The remaining is then dried and weighed.

Dispersibility is calculated according to the equation:

Calculate the dispersibility of the WG by the formula:

$$Dispersibility = \frac{10}{9} \cdot \frac{m - W}{m} \cdot 100 \%$$

where:
W=mass of residue after drying (g)
M=mass of sample taken

### Results:

No. of inversions of the water dispersible solid composition of Example 1, Table 2 (with Silwet L77): 17 (before and after storage for 14 days at 54° C.).
No. of inversions of the water dispersible solid composition of Example 2, Table 3 (without Silwet L77): 24 (before and after storage for 14 days at 54° C.).
Dispersibility of Example 1 is 95% before and after accelerated storage and 85% for Example 2 (without Silwet L-77)

### Suspensibility Measurement (Suspensibility Values are Calculated According to CIPAC Method, MT 184)

Stable water dispersible solid compositions that form suspensions on dilution are those that provide and maintain good suspensibility, defined by a value greater than 80% and preferably >85% after a period of storage, while values that exceed 105% or below 60% when tested after the period of storage, are considered as non-stable.

Suspensibility was tested in the following manner:

0.075 gr of water dispersible solid composition (800 WDG 02, d90 is 14; or 800 WDG 03, d90 is 17) or example 2, was added to a cylinder containing 250 ml water (342 ppm salinity) (240 mg novaluron pre 1 liter water), the material was dispersed by shaking up and down the cylinder 10 times. After 30 m. the top 90% of the suspension was evacuated and the amount of material left in the bottom was analytically determined. Suspensibility was tested at expected field rate of 0.24 gr novaluron per 1 liter water. Results are shown in Table 4.

TABLE 4

| | Suspensibility | Suspensibility |
|---|---|---|
| | before storage | after storage |
| | (14 days at | (14 days at |
| Sample | 54° C.) | 54° C.) |
| Granules, ready-mix, with | 85-90% | 85-90% |
| Silwet L77 | | |
| (Example 1 where the d90 is | | |
| 17 or 14, Table 2) | | |
| Granules without Silwet L77 | 80%-85% | 65%-75% |
| (Example 2 where the d90 is | | |
| 17, Table 3) | | |

### Example 3: Combination of Novaluron and Organo-Silicone Based Surfactant as Tank Mix

Silwet L77 (0.5 gr) was added to 1 liter of water and stirred to obtain clear solution. Novaluron water dispersible solid composition (Example 2, 0.75 gr, where the particle size distribution d90 is 17) was added to the solution and mixed to obtain homogenous suspension.

### Conclusion

Combining the organo-silicone based surfactant within or as tank with a water dispersible solid composition comprising novaluron improves the wettability of water dispersible solid composition comprising novaluron and suspensibility of the novaluron as particles in water.

### Example 4. Biological Experiment, Efficacy of the Novaluron Granules

Objective: Comparison of 3 novaluron compositions to commercial insecticide product Rimon® 10EC (novaluron) in ingestion assay with Spodoptera Littorals 2nd instar larvae (L2).

Assay type: Ingestion of sunflower leaf disk inside petri dishes. 120 hours.

15 petri dishes for each treatment with 2 L2 larva in each petri.

Treatments: two compositions of example 1 and same composition where the particle size is 6 microns
800 WDG 01—composition of example 1 with particle size D90 is 6 microns
800WDG-02—composition of example 1 with particle size D90 is 14 microns (example 1)
800WDG-03—composition of example 1 with particle size D90 is 17 microns (example 1)
Rimon® 10EC
Water

Efficacy of the three Novaluron 800 WDG compositions 01, 02 and 03 were compared to Rimon® 10EC (commercial standard) against Spodoptera Littoralis in terms of population mortality, following exposure to treated sunflower detach leaf.

### Methodology

Test system. Spodoptera Littoralis larvae were obtained from a laboratory culture maintained at the biokinetic lab. Prior to the start of the experimental phase, the culture was maintained on sunflower (Helianthus Annuus) leaves. For the bioassay, 2nd instar larvae were selected.

Test treatments and application., Three compositions of Novaluron 800 WDG; 800WDG-01, 800WDG-02, 800WDG-03 with different particle size were evaluated alongside Rimon 10EC (commercial format) and a water control. The water control treatment was included as a comparative measure to assess the batch fitness/survival of insects and to observe natural population dynamics under imposed trial conditions. All novaluron compositions were tested at 1 rate: 0.08 ppm.

Treatments were applied as a foliar application by dipping detached sunflower leaves inside beakers containing 200 mL of the composition's solution for five seconds. The leaves were then set to air dry inside chemical hood until fully dried. The treatments are summarized in Table 5.

TABLE 5
1^{st} stage - trial INS_68

| | Ai concentration |
|---|---|
| Treatment name | (ppm) |
| Rimon ® 10EC | 0.08 |
| WDG-01 | 0.08 |
| WDG-02 | 0.08 |
| WDG-03 | 0.08 |

Experimental design. Sunflower plants were grown under laboratory conditions to BBCH stage 18. Test treatments were delivered as foliar applications by leaf dipping as described above.

Following a 2 hour-period to allow for drying in the hood, the treated leaves were placed inside 60 mm petri dish containing Agar that helps to keep the leaf vigorous during the experiment. Once all the leaves were placed inside the petri dishes, infestation of the larvae took place.

Using a fine brush, the larvae were removed from the Spodoptera Littoralis colony to the petri dish. In each dish, 2 larvae were placed and then closed with specially designed ventilated lid. The lid was then sealed with parafilm and the petri dishes placed in the insect room (temperature of 24° C. to 26° C. and photoperiod of 16 h light/8 h dark) for 120 hours.

Following the 120 hours period where the larvae fed from the treated leaves, the petri dished were unsealed and the number of dead and live larvae was evaluated with the assistance of the fine brush.

Mortality rate was then calculated as:

$$\frac{number of dead larvae at the end}{number of live larvae at the start} * 100 ,$$

for every replica individually. Mortality rate for a single treatment is the average mortalities of the 15 replicates in the treatment.

Replication—15 replicates for every treatment, number of larvae in every replicate is 2, total of 30 insects per treatment.

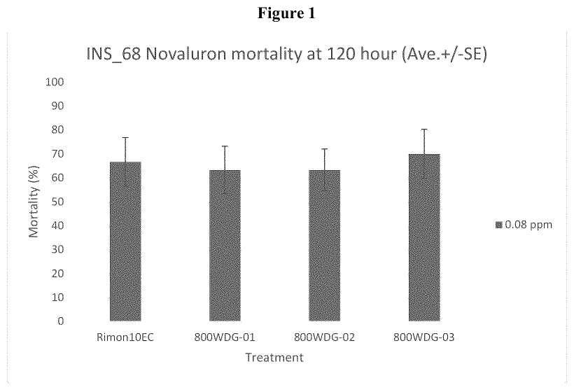

Efficacy results are showed in FIG. 1.

### Example 5. Chlorosis Evaluation of Composition Prototypes on Pepper Crop

Materials, Rimon® 10 EC (novaluron, manufactured and sold by ADAMA), Novaluron 800 WDG-02, Novaluron 800 WDG-03

Rates: 60 g Ai/Ha; equiv. to 100% FR

Replicates: 4 replicates per treatment.

Application: POSTEM, applied with calibrated hand sprayer, equivalent to 350 L/Ha, sprayed individually at each pepper plant

Model plants:

Pepper plants, grown at Hishtilto 3-4 true leaves stage, replanted in sieved sand at BKL 7 days before the start.

Evaluation: Imaging, visual damage evaluation and phenotyping, at DAS_21.

Measurements were expressed as arbitrary scoring scale shown in Table 8.

Treatments are summarized in Table 6.

TABLE 6

| Pots# | Treatment description | Exp. set |
|---|---|---|
| 1-4 | Water (UNTR control) | 1 |
| 5-8 | Rimon ® 10 EC (Novaluron) | 2 |
| | STD | |
| 13-16 | Novaluron 800 WDG-02 | 4 |
| 17-20 | Novaluron 800 WDG-03 | 5 |

Growth conditions:

Young trans plants (4 weeks) were re-planted in pots at the green house (20-25° C., RH˜50%) for 7 days.

After the composition's application, plants were grown at the green house (same conditions) for an additional 14 days.

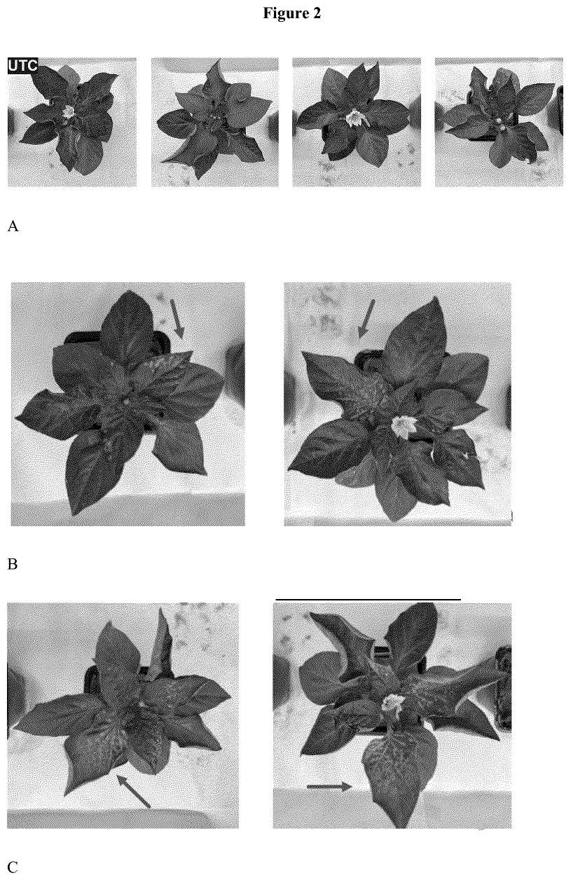

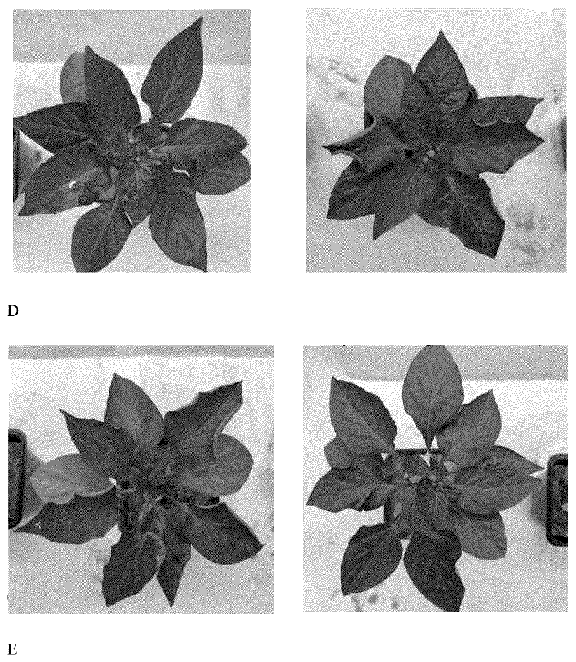

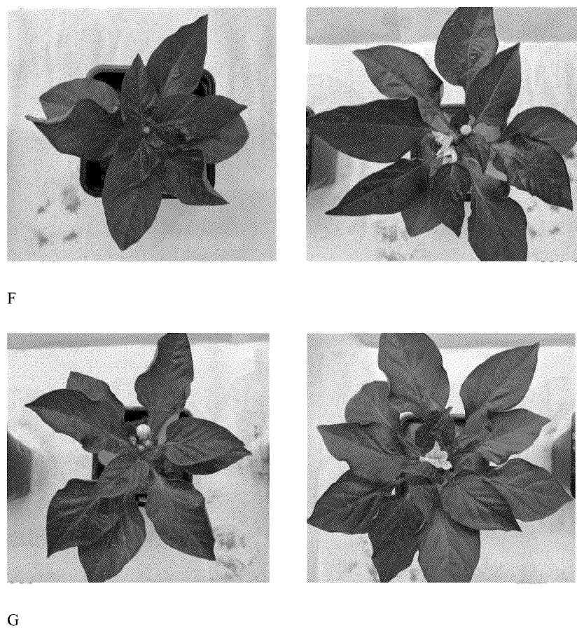

Chlorosis (visible yellow dots) was assessed after 21 days. Results are showed in Table 7 and FIG. 2 (A-I: A nontreated, controlled; B and C, treated with novaluron 10 EC composition; D and E, treated with novaluron 800 WDG-02 composition; F and G, treated with novaluron 800 WDG-03 composition).

TABLE 7
Chlorosis in pepper crop.

| Treatment | DAS21 Chlorosis |
|---|---|
| UTC | 0.00 |
| Rimon ® 10 EC (novaluron) STD | 2.25 |
| Novaluron 800 WDG-02 | 0.00 |
| Novaluron 800 WDG-03 | 0.00 |

TABLE 8
Scale for Chlorosis

| Index | Interpretation* |
|---|---|
| 0 | 0 |
| 1 | 10 |
| 2 | 25 |
| 3 | 50 |
| 4 | 75 |
| 5 | >75 |

*(percentage of yellow dots in present leaves after spraying)

1. A combination of novaluron and organo-silicone based surfactant.

2. The combination of claim 1, wherein the combination is a mixture comprising (i) solid particles of novaluron, (ii) organo-silicone based surfactant, and (iii) water, wherein the solid particles of novaluron are dispersed in water.

3. (canceled)

4. The combination of claim 1, wherein;
a) the solid particles of novaluron have a particle size distribution D90 between 5 to 20 microns, preferably between 10 to 20 microns, more preferably 20 microns or less,
b) the organo-silicone based surfactant is an organo-modified tri-siloxane, preferably wherein:
(i) the organo-silicone based surfactant has the following structure: 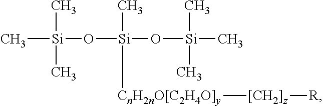
wherein n=1-4, y=3-10, z=0-5, and R is an alkyl having 1-4 carbon atoms or H or OH, or
(ii) the organo-silicone based surfactant is 3-(8-methoxyoctoxy) propyl-methyl-bis(trimethylsilyloxy) silane,
c) the weight ratio between the organo-silicone based surfactant and the novaluron in the combination is between 1:2 to 50:1, and/or
d) the combination further comprises an agriculturally acceptable additive selected from the group consisting of dispersing agent (s), wetting agent (s), filler (s), binder (s), anti-foaming agent (s), biocide (s), water absorbent (s), water scavenger (s), adjuvant (s), or any combination thereof, preferably wherein at least one agriculturally acceptable additive is in the form of solid particles and the solid particles have a particle size distribution d90 of 20 microns or less,
e) the combination comprises (i) a water dispersible solid composition comprising novaluron, and (ii) an organo-silicone based surfactant.

5. (canceled)

6. (canceled)

7. (canceled)

8. (canceled)

9. (canceled)

10. (canceled)

11. (canceled)

12. The combination of claim 1, wherein the combination is a water dispersible solid composition comprising (i) novaluron and (ii) an organo-silicone based surfactant, preferably a ready-mix water dispersible solid composition, more preferably a granular composition or a powder composition.

13. The combination of claim 12, wherein:
a. the amount of novaluron in the water dispersible solid composition is between about 10% to about 95% w/w based on the total weight of the composition, preferably the water dispersible solid composition is high-load with 50-95% w/w of novaluron based on the total weight of the composition, more preferably about 80% w/w of novaluron based on the total weight of the composition,
b. the amount of organo-silicone based surfactant in the water dispersible solid composition is between about 0.5% to about 5% w/w based on the total weight of the composition, preferably between about 18 to about 38 w/w based on the total weight of the composition, more preferably about 1.5% w/w based on the total weight of the composition,
c. the organo-silicone based surfactant is an organo-modified tri-siloxane, preferably wherein:
(i) the organo-silicone based surfactant has the following structure: 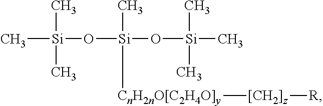
wherein n=1-4, y=3-10, z=0-5, and R is an alkyl having 1-4 carbon atoms or H or OH, or
(ii) the organo-silicone based surfactant is 3-(8-methoxyoctoxy) propyl-methyl-bis(trimethylsilyloxy) silane,
d. the weight ratio between the organo-silicone based surfactant and the novaluron in the water dispersible solid composition is between 1:100 to 5.5:100, preferably between 1:50 to 1:55, more preferably about 1.5:80,
e. the water dispersible solid composition comprises a wetting agent and/or a dispersing agent, preferably wherein:
(i) the wetting agent is selected from the group consisting of sodium alkylnaphthalenesulfonate, sodium phenolsulfonic acid, polycondensed formaldehyde, alcohol ethoxylate, sodium lauryl sulfate, polyalkoxylated butyl ether, polyarylphenyl phosphate ether, sodium ducosate, and any combination thereof, preferably the wetting agent is sodium alkylnaphthalenesulfonate,
(ii) the amount of wetting agent in the water dispersible solid composition is between about 28 to about 5% w/w based on the total weight of the composition, preferably about 3% w/w based on the total weight of the composition,
(iii) the dispersing agent is an ionic or anionic compound and/or the dispersing agent has a polymeric structure, preferably wherein the dispersing agent is selected from the group consisting of condensate of alkyl naphthalene sulfonate formaldehyde, methyl naphthalene sulfonate condensate, sodium salt, ethoxylated fatty alcohol, hydrophobically modified polyacrylate, lignosulfonates, polyelectrolyte block copolymer, and any combination thereof, preferably the dispersing agent is a modified sodium lignosulphonate, a modified styrene acrylic polymer, or a combination thereof, more preferably the dispersing agent is a block copolymer comprising 77% of sodium 2-acryloylamino-2-methylpropane-1-sulfonate (AMPS) monomers and 23% of the ethyl acrylate (EA) monomers, and/or
(iv) the amount of dispersing agent (s) in the water dispersible solid composition is between about 1% to about 15% w/w based on the total weight of the composition, preferably about 98 w/w based on the total weight of the composition,
f. the water dispersible solid composition is substantially free or free of liquid oily additive and/or liquid organic additive,
g. the water dispersible solid composition comprises an agricultural acceptable solid additive, preferably wherein:
(i) the agricultural acceptable solid additive is a filler and/or binder,
(ii) the agriculturally acceptable solid additive is selected from the group consisting of silica, clay, corn starch, talc, lactose monohydrate, ammonium sulfate, sucrose, magnesium stearate, glucose, cellulose, calcium carbonate, and any combination thereof, preferably the agriculturally acceptable solid additive is a combination of corn starch and talc, and/or
(iii) the amount of the agriculturally acceptable solid additive(s) in the water dispersible solid composition is between about 28 to about 50% w/w based on the total weight of the water dispersible solid composition, preferably about 6.5% w/w based on the total weight of the water dispersible solid composition,
h. the water dispersible solid composition comprises a functional additive selected from the group consisting of anti-foaming agent, biocides, absorbents, water scavengers, adjuvants and any combination thereof, and/or
i. the water dispersible solid composition is prepared using novaluron in solid form.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. The combination of claim 1, wherein the combination is water dispersible solid composition comprising:
a. novaluron in amount of about 80% based on the total weight of the composition,
b. organo-silicone based surfactant in amount of about 1.5% based on the total weight of the composition,
c. dispersing agent (s) in amount of about 9% w/w based on the total weight of the composition,
d. wetting agent in amount of about 3% w/w based on the total weight of the composition, and
e. agriculturally acceptable solid additive in amount of about 6.5% w/w based on the total weight of the composition.

26. A water dispersible solid composition comprising novaluron.

27. A suspension comprising the water dispersible solid composition of claim 12 and water.

28. A method for controlling unwanted insects or plant disease caused by unwanted insect comprising applying an effective amount of the combination of claim 1 to a plant, a locus thereof, propagation material thereof, or an area infested with the unwanted insects so as to thereby control the unwanted insects or the plant disease caused by the unwanted insect.

29. (canceled)

30. A method for controlling unwanted insects or plant disease caused by unwanted insect comprising (1) obtaining a suspension comprising the combination of claim 1 and water, and (2) contacting a plant, a locus thereof, propagation material thereof, or an area infested with the unwanted insects with an effective amount of the suspension so as to thereby control the unwanted insects or the plant disease caused by the unwanted insect.

31. (canceled)

32. The method of claim 30, wherein step (1) comprises (i) obtaining a water dispersible solid composition of claim 12, and (ii) mixing the water dispersible solid composition with water to obtain the suspension.

33. The method of claim 32, wherein:
a. the water dispersible solid composition obtained in step (1) (i) comprises an organo-silicone based surfactant,
b. the water dispersible solid composition obtained in step (1) (i) is substantially free or free of organo-silicone based surfactant and step (1) (ii) comprises mixing an organo-silicone based surfactant with the water dispersible solid composition and water, or
c. the water dispersible solid composition obtained in step (1) (i) comprises an organo-silicone based surfactant and step (1) (ii) comprises mixing an organo-silicone based surfactant with the water dispersible solid composition and water.

34. The method of claim 33, wherein:
a. step (1) (ii) comprises mixing the organo-silicone based surfactant with water before the water dispersible solid composition is mixed with water,
b. step (1) (ii) comprises mixing the water dispersible solid composition with water before the organo-silicone based surfactant is mixed with water, or
c. step (1) (ii) comprises mixing the water dispersible solid composition and the organo-silicone based surfactant with water simultaneously.

35. The method of claim 28, wherein:
a. the locus of the plant is the vicinity of the plant, optionally the plant is a pesticide sensitive crop, preferably cucumber, lettuce, pepper, cabbage, wine grapes or cucurbit,
b. the area infested with unwanted insects is soil,
c. the method is effective for preventing infestation by unwanted insects and/or reducing the number of unwanted insects or preventing the plant disease caused by unwanted insects and/or curing the plant disease caused by unwanted insects
d. the combination, composition or suspension is applied at a rate from about 100 ppm to about 1000 ppm of novaluron, preferably from about 200 ppm to about 500 ppm of novaluron,
e. the combination, composition or suspension is applied to soil, or the combination, composition or suspension is applied to foliage, and/or
f. the insects are selected from group consisting of orders Lepidoptera, Coleoptera, Homoptera, Heteroptera, Diptera, Thysanoptera, Orthoptera, Anoplura, Siphonaptera, Mallophaga, Thysanura, Isoptera, Psocoptera and Hymenoptera, as well as representatives of the order Acarina of the families Ixodidae Argasidae, Tetranychidae and Dermanyssidae, leaf rollers and any combination thereof, preferably the insects are selected from the group consisting of Musca domestica, termites, cockroaches, mosquito larvae and any combination thereof.

36. (canceled)

37. (canceled)

38. A process for preparing the water dispersible solid composition of claim 26, the process comprising (1) mixing novaluron in solid form with at least one agriculturally acceptable additive in solid form to prepare a pre-mix, (2) milling the premix of step (1) to prepare a milled blend, (3) wetting the milled blend with a wetting liquid, (4) perform wet granulation and drying.

39. The process of claim 38, wherein:
a. the agriculturally acceptable additive is selected from the group consisting of dispersing agent, wetting agent, filler, binder, anti-foaming agent, biocides, water absorbents, water scavengers, adjuvants and any combination thereof,
b. the wetting liquid is a water-based wetting solution comprising organo-silicone based surfactant, preferably the wetting liquid is a combination of (1) a water-based wetting solution comprising organo-silicone based surfactant, and (2) water,
c. the process further comprises addition of water prior step (4),
d. the process comprises (1) preparing a mixture of novaluron having particle size of 10 to 20 microns with a wetting agent, a dispersing agent and optionally a solid additive, (2) wet granulation of the mixture of step (1) using a water-based wetting liquid comprising organo-silicone based surfactant to obtain a wetted solid composition, and (4) drying the obtained wetted solid composition, preferably wherein water is used for wet granulation, preferably wherein the amount of water used for wet granulation is between 7 to 20% w/w based on the total weight of the wetted solid composition before drying, more preferably the amount of water used for wet granulation is about 8.58 w/w based on the total weight of the wetted solid composition before drying,
e. the wet granulation is performed by extrusion process, the wet granulation is pan granulation, or the wetting liquid is sprayed onto the mixture of step (2) to obtain granules, and/or
f. the granules are dried using a fluidized bed, by lyophilization of the remaining solution, by spray-drying, by freeze-drying, by diafiltration, by dialysis, by vacuum drying, and/or by heat drying.

40. The process of claim 39, wherein:
a. the water-based solution comprising organo-silicone based surfactant is added first followed by additional amount of water, or
b. the additional water is added after adding the water-based wetting solution comprising organo-silicone based surfactant.

41. (canceled)

42. (canceled)

43. (canceled)

44. (canceled)

45. A process for preparing the suspension of claim 27, wherein the suspension comprises (i) solid particles of novaluron, (ii) organo-silicone based surfactant, and (iii) water, and wherein the solid particles of novaluron are dispersed in water, wherein the process comprises:
a. mixing (a) a water dispersible solid composition comprising novaluron and an organo-silicone based surfactant, and (b) water, or
b. mixing (a) a water dispersible solid composition comprising novaluron, (b) an organo-silicone based surfactant, and (c) water.

46. (canceled)

47. A package comprising the combination of claim 1, wherein:
a. the combination is a water dispersible solid composition comprising (a) novaluron and (b) an organo-silicone based surfactant,
b. the combination is (a) a water dispersible solid composition comprising novaluron, and (b) an organo-silicone based surfactant, wherein the water dispersible solid composition is substantially free or free of organo-silicone based surfactant, or
c. the combination is (a) a water dispersible solid composition comprising novaluron, and (b) an organo-silicone based surfactant, wherein the water dispersible solid composition comprises an organo-silicone based surfactant.

48. A method of dispersing novaluron in the form of solid particles in water, wherein the method comprises using an organo-silicone based surfactant for dispersing the novaluron in the form of solid particles in water.

49. (canceled)

50. (canceled)
